(19) United States
(12) Patent Application Publication
(10) Pub. No.: US 2022/0405340 A1
(43) Pub. Date: Dec. 22, 2022

(54) Interactive Representation of Real-Estate Search Results

(71) Applicant: Estate Legend, Inc., South San Francisco, CA (US)

(72) Inventors: Martin Kirkwood, South San Francisco, CA (US); Raymond Gutierrez, South San Francisco, CA (US); Shmuel Silverman, Novato, CA (US)

(73) Assignee: Estate Legend, Inc., South San Francisco, CA (US)

(21) Appl. No.: 17/743,396

(22) Filed: May 12, 2022

Related U.S. Application Data
(60) Provisional application No. 63/212,097, filed on Jun. 17, 2021.

(51) Int. Cl. G06F 16/9538; G06F 16/9535

(52) U.S. Cl. CPC G06F 16/9538; G06F 16/9535; G06Q 50/16

(57) ABSTRACT

A real-estate system dynamically learns user profiles associated with users based at least in part on dynamic interaction of the users in a virtual environment that presents three-dimensional (3D) representations of available real-estate properties. Notably, the real-estate system may perform searches of available real-estate properties based at least in part on a search query associated with a user or an individual that is associated with or related to the user, and a user profile that includes information specifying real-estate interests of the user. Then, the real-estate system may provide or present search results in the virtual environment, where the virtual environment includes an avatar corresponding to the user or the individual and a 3D representation of a real-estate property. The virtual environment allows the user or the individual to dynamically explore and view the real-estate property, as well as to provide feedback about real-estate elements in the real-estate property.

### CROSS REFERENCE TO RELATED APPLICATIONS

This application claims priority under 35 U.S.C. 119(e) to U.S. Provisional Application Ser. No. 63/212,097, entitled “Interactive Representation of Real-Estate Search Results,” by Martin Kirkwood, et al., filed on Jun. 17, 2021, the contents of which are herein incorporated by reference.

### FIELD

The described embodiments relate to a real-estate system that performs real-estate searches and that presents search results in a virtual environment.

### BACKGROUND

Humans often have a limited ability to address the needs of others. While people attempt to know and understand someone's needs, it is difficult to do this accurately. In the absence of such awareness, efforts to fulfill these needs may fall short or may go awry.

Some of the magic or charm and expertise that a real estate professional brings to real estate transactions is knowing the real-estate market and being able to address the preferences and predilections of their client. Addressing a buyer's needs well involves understanding their requirements and their dreams (such as architectural style/genre, floor plan/layout, orientation of a property, materials, features, textures, color, proximity to buyers' interests, etc.).

However, developing a deep insight into what a buyer wants and what they need, typically takes considerable time and effort. This high-touch service often constrains how many clients a real-estate professional can work with at any given time. These inefficiencies are frustrating to clients and real-estate professionals.

### SUMMARY

In a first group of embodiments, a computer system that performs a search is described. This computer system may include: an interface circuit that communicates with an electronic device (which may be remotely located from the computer system); a computation circuit (such as a processor or a graphics processing unit or GPU); and memory that stores a user profile associated with a first individual and program instructions. During operation, the computer system receives a search query associated with a second individual. Then, the computer system accesses the user profile, where the user profile includes information specifying real-estate interests of the first individual. Moreover, the computer system performs the search of available real-estate properties based at least in part on the search query and the user profile. Next, the computer system presents search results in a virtual environment, where the virtual environment includes an avatar corresponding to the first individual and a three-dimensional (3D) representation of a real-estate property (such as a house, an apartment, a condominium, a building, or land), and the virtual environment allows the avatar to dynamically explore and view the real-estate property.

Note that the first individual may be different from the second individual. For example, the first individual and the second individual may be related.

Moreover, the user profile may include real-estate elements that the first individual likes or dislikes, and the information may be expressed in an architectural language.

Furthermore, the computer system may: receive feedback about the real-estate property; and dynamically modify the user profile based at least in part on the feedback. Note that the dynamic modification may include translating the feedback into the architectural language used to express the information. Moreover, the feedback may include a tag assigned to a real-estate element in the real-estate property by the second individual. Alternatively or additionally, the feedback may include second information specifying an emotional response of the second individual. For example, the second information may include one or more images of the second individual, and the one or more images may include: a gesture, a facial expression, body motion, and/or body language of the second individual; or natural language of the second individual. In some embodiments, the dynamic modification may be performed by a pretrained supervised-learning model (such as a machine-learning model or a neural network). Additionally, the computer system may retrain the pretrained supervised-learning model based at least in part on the modified user profile.

Moreover, the virtual representation may present the real-estate property in a 3D context of a second environment that comprises the real-estate property. For example, the context may include: a building that comprises the real-estate property; and/or one or more buildings that are proximate to the real-estate property.

Furthermore, the search query may include or may correspond to or specify an identified real-estate property that is of interest to the second individual.

Additionally, the user profile may be uniquely associated with the first individual. For example, the user profile may be uniquely tied to the first individual using a blockchain.

In some embodiments, the 3D representation of the real-estate property may be generated using a second pretrained supervised-learning model (such as a machine-learning model or a neural network).

Another embodiment provides the electronic device.

Another embodiment provides a computer-readable storage medium for use with the computer system. When executed by the computer system, this computer-readable storage medium causes the computer system to perform at least some of the aforementioned operations.

Another embodiment provides a method that may be performed by the computer system. This method includes at least some of the aforementioned operations.

In a second group of embodiments, a computer system that performs a search is described. This computer system may include: an interface circuit that communicates with an electronic device; a computation circuit; and memory that stores a user profile associated with a first individual and program instructions. During operation, the computer system the computer system receives a search query associated with a second individual. Then, the computer system may access the user profile, where the user profile includes information specifying real-estate interests of the first individual. Moreover, the computer system performs the search of available real-estate properties based at least in part on the search query and the user profile. Next, the computer system analyzes the available real-estate properties to assess a need, ability and/or suitability for modification based at least in part on the user profile and the search query. Furthermore, the computer system filters search results to exclude a subset of the available real-estate properties that are unable to be modified, or for which an estimated time and/or an estimated cost of modification (such as remodeling) exceeds predefined threshold values. Additionally, the computer system presents the filtered search results.

Note that the computer system may present the filtered search results in a virtual environment, where the virtual environment includes an avatar corresponding to the first individual and a 3D representation of a real-estate property, and the virtual environment allows the avatar to dynamically explore and view the real-estate property. In some embodiments, the 3D representation of the real-estate property is modified from an existing state of the real-estate property based at least in part on the user profile. For example, the virtual environment may include a predefined architectural, landscape or interior design and the 3D representation of the real-estate property is modified from an existing state of the real-estate property based at least in part on the predefined architectural, landscape or interior design. The modified 3D representation of the real-estate property may be presented using a hologram. Moreover, the computer system may print or generate a 3D model of the modified 3D representation of the real-estate property (e.g., using a 3D printer). Furthermore, the computer system may provide a recommendation for a contractor to modify an existing state of the real-estate property (e.g., based at least in part on the modification).

Another embodiment provides the electronic device.

Another embodiment provides a computer-readable storage medium for use with the computer system. When executed by the computer system, this computer-readable storage medium causes the computer system to perform at least some of the aforementioned operations.

Another embodiment provides a method that may be performed by the computer system. This method includes at least some of the aforementioned operations.

In a third group of embodiments, a computer system that performs a search is described. This computer system may include: an interface circuit that communicates with an electronic device; a computation circuit; and memory that stores a user profile associated with a first individual and program instructions. During operation, the computer system the computer system receives a search query associated with a second individual. Then, the computer system may access the user profile, where the user profile includes information specifying real-estate interests of the first individual. Moreover, the computer system performs the search of available real-estate properties based at least in part on the search query and the user profile. Next, the computer system presents search results. Furthermore, the computer system logs virtual access, by the second individual, to the real-estate property.

Additionally, the computer system may: receive a request associated with the logged virtual access to the real-estate property based at least in part on an occurrence of an event (such as a crime proximate to or in the real-estate property); and selectively provide information specifying the second individual (such as when the request is from or is associated with an authorized requestor). For example, the request may be received from or associated with: an owner of the real-estate property, a renter of the real-estate property, law enforcement or a government agency.

Moreover, the computer system may filter the search results to exclude a subset of the available real-estate properties based at least in part on security settings associated with the available real-estate properties in the subset. For example, a given security setting may specify an allowed type of viewer (such as when the first individual or the second individual is a prequalified buyer, currently own another real-estate property and/or is a casual viewer that is not planning to purchase or make an offer for the real-estate property). Furthermore, the filtering may be based at least in part on: a history of searches and/or search behaviors of the first individual and/or the second individual; and/or an estimated security risk associated with the first individual and/or the second individual, which may be computed based at least in part on the user profile. Alternatively or additionally, the computer system may obfuscate or remove secondary information associated with the real-estate property in a 3D representation of the real-estate property based as least in part on: the given security setting; the history of searches and/or or search behaviors; and/or the search results. Note that the secondary information may include security information, such as information about an alarm system (e.g., presence or absence of an alarm system, a type of the alarm system, coverage of an alarm system, etc.), a lock, and/or a security camera (e.g., presence or absence of a security camera, a type of security camera, coverage associated with a security camera, etc.).

In some embodiments, the computer system may filter the search results to exclude a subset of the available real-estate properties based at least in part on a purchasing state associated with the first individual and/or second individual (such as whether or not the first individual and/or the second individual are prequalified buyers, currently own another real-estate property and/or is a casual viewer that is not planning to purchase or make an offer for the real-estate property). Alternatively or additionally, the user profile may include real-estate elements that the first individual likes or dislikes, and associated estimated costs associated with the real-estate elements, and the computer system may filter the search results to exclude a subset of the available real-estate properties based at least in part on an estimated cost (such as an estimated cost of a real-estate element) and an approved purchasing capability associated with the second individual. Note that the purchasing capability may correspond to a financial history associated with the second individual (such as an approved range of mortgages, a credit history, etc.). Moreover, the estimated costs may be computed by a pretrained supervised-learning model (such as a machine-learning model or a neural network). Furthermore, the user profile may include identified materials associated with the real-estate elements.

Another embodiment provides the electronic device.

Another embodiment provides a computer-readable storage medium for use with the computer system. When executed by the computer system, this computer-readable storage medium causes the computer system to perform at least some of the aforementioned operations.

Another embodiment provides a method that may be performed by the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for performing a search using a computer system of FIG. 1 in accordance with an embodiment of the present disclosure.

FIG. 3 is a drawing illustrating an example of generating a world data structure or database using a pattern language in accordance with an embodiment of the present disclosure.

FIG. 4 is a drawing illustrating an example of mapping 3D depictions into an architectural pattern language (APL) in accordance with an embodiment of the present disclosure.

FIG. 5 is a drawing illustrating an example of mapping natural language processing (NLP) 3D to APL in accordance with an embodiment of the present disclosure.

FIG. 6 is a drawing illustrating an example of mapping APL to NLP and 3D in accordance with an embodiment of the present disclosure.

FIG. 7 is a drawing illustrating an example of features that modify APL elements (APLE) in accordance with an embodiment of the present disclosure.

FIG. 8 is a drawing illustrating an example of an APLE neural network in accordance with an embodiment of the present disclosure.

FIG. 9 is a drawing illustrating an example of an NLP and APL neural network in accordance with an embodiment of the present disclosure.

FIG. 10 is a drawing illustrating an example of feature and node connections in accordance with an embodiment of the present disclosure.

FIG. 11 is a drawing illustrating an example of machine learning (ML) inputs in accordance with an embodiment of the present disclosure.

FIG. 12 is a drawing illustrating an example of an avatar makeup in accordance with an embodiment of the present disclosure.

FIG. 13 is a drawing illustrating an example of mapping 3D to APL and NLP in accordance with an embodiment of the present disclosure.

FIG. 14 is a drawing illustrating an example of creating a simulated environment in accordance with an embodiment of the present disclosure.

FIG. 15 is a drawing illustrating an example of building an avatar in accordance with an embodiment of the present disclosure.

FIG. 16 is a drawing illustrating an example of building a phenotype based at least in part on human interaction and experience in accordance with an embodiment of the present disclosure.

FIG. 17 is a drawing illustrating an example of avatar behavioral hysteresis in accordance with an embodiment of the present disclosure.

FIG. 18 is a drawing illustrating an example of merging persona weights in accordance with an embodiment of the present disclosure.

FIG. 19 is a drawing illustrating an example of producing phenotypes using genotypes in accordance with an embodiment of the present disclosure.

FIG. 20 is a drawing illustrating an example of adding nodes and connections in accordance with an embodiment of the present disclosure.

FIG. 21 is a drawing illustrating an example of matching genomes for different network topologies in accordance with an embodiment of the present disclosure.

FIG. 22 is a drawing illustrating an example of privacy protection of avatars in accordance with an embodiment of the present disclosure.

FIG. 23 is a drawing illustrating an example of a financial planning call flow in accordance with an embodiment of the present disclosure.

FIG. 24 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that performs a search is described. This computer system may include: an interface circuit that communicates with an electronic device (which may be remotely located from the computer system); a computation circuit (such as a processor or a graphics processing unit or GPU); and memory that stores a user profile associated with a first individual and program instructions. During operation, the computer system may receive a search query associated with a second individual. Then, the computer system may access the user profile, where the user profile includes information specifying real-estate interests of the first individual. Moreover, the computer system may perform the search of available real-estate properties based at least in part on the search query and the user profile. Next, the computer system may present search results in a virtual environment, where the virtual environment includes an avatar corresponding to the first individual and a 3D representation of a real-estate property (such as a house, an apartment, a condominium, a building, or land), and the virtual environment allows the avatar to dynamically explore and view the real-estate property.

Alternatively or additionally, after or while performing the search, the computer system may analyze the available real-estate properties to assess a need, ability and/or suitability for modification based at least in part on the user profile and the search query. Furthermore, the computer system may filter search results to exclude a subset of the available real-estate properties that are unable to be modified, or for which an estimated time and/or an estimated cost of modification exceeds predefined threshold values. However, in other embodiments, the computer system may filter the search results to exclude a subset of the available real-estate properties based at least in part on: security settings associated with the available real-estate properties in the subset; a history of searches and/or search behaviors of the first individual and/or the second individual; an estimated security risk associated with the first individual and/or the second individual; a purchasing state associated with the first individual and/or second individual; estimated costs associated with real-estate elements; preferences of the first individual and/or second individual; and/or an approved purchasing capability associated with the second individual. Additionally, the computer system may present the filtered search results.

In some embodiments, the computer system logs virtual access, by the second individual, to the real-estate property. Subsequently, in response to a request associated with the logged virtual access (e.g., from an authorized requestor), the computer system may provide information specifying or identifying the second individual. Alternatively or additionally, the computer system may obfuscate or remove secondary information (such as sensitive or personal information, security information, etc.) associated with the real-estate property in a 3D representation of the real-estate property based as least in part on: a security setting; a history of searches and/or or search behaviors; and/or the search results.

By providing the search results in an interactive virtual environment, these search techniques may provide an improved real-estate shopping experience.

Notably, the search techniques may allow the preferences and needs of an individual to be efficiently and seamlessly determined while the individual interacts with real-estate properties. Moreover, the search techniques may allow the individual to visual and explore modifications to suitable real-estate properties. Furthermore, the search techniques may integrate security features for the benefit of buyers and sellers. Consequently, the search techniques may reduce the time and effort needed to identify real-estate properties that are of interest, thereby providing the additional benefits of scalability and reduced opportunity and financial costs. By improving the user experience while provide the additional benefits, the search techniques may increase commercial activity.

In some embodiments, at least a portion of the search techniques may be implemented in a distributed or decentralized manner. Alternatively, in some embodiments, at least a portion of the search techniques may be implemented in a centralized manner.

In the discussion that follows, electronic devices may communicate packets or frames with wired and/or wireless networks (e.g., via access points, radio nodes and/or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols may be used. Note that the wireless communication may occur in a variety of frequency bands, such as: a cellular-telephone communication band, a frequency band associated with a Citizens Band Radio Service, a Wi-Fi frequency band (such as a 2.4 GHz, a 5 GHz, a 6 GHz and/or a 60 GHz frequency band), etc.

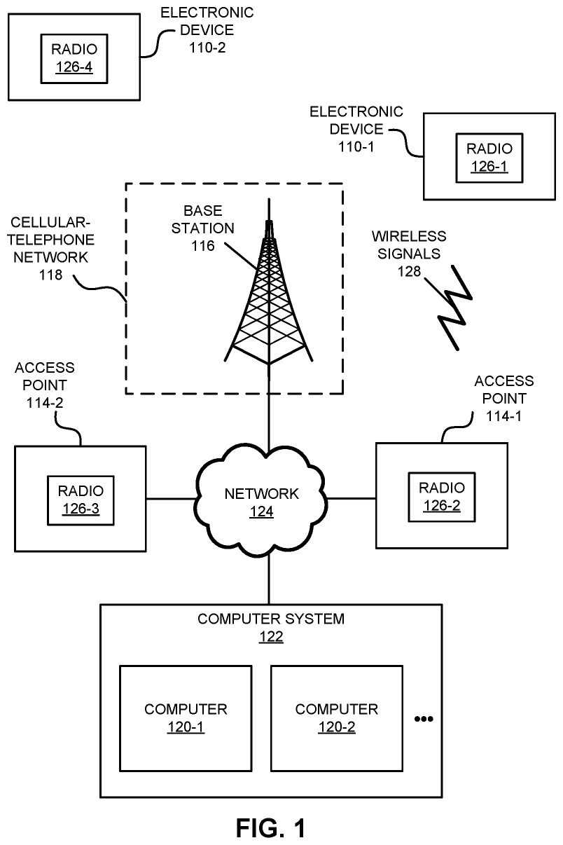

FIG. 1 presents a block diagram illustrating an example of communication among one or more of electronic devices 110 (such as a cellular telephone, a computer, an augmented or virtual-reality headset, etc., and which are sometimes referred to as ‘clients’), access points 114, base station 116 in cellular-telephone network 118, and one or more computers 120 in computer system 122 in accordance with some embodiments. Access points 114 and base station 116 may communicate with computer system 122 via network 124 (such as the Internet) using wireless and/or wired communication (such as by using Ethernet or a communication protocol that is compatible with Ethernet), and may communicate with electronic devices 110 using wireless communication (Wi-Fi and a cellular-telephone communication protocol, respectively). Note that access points 114 may include a physical access point and/or a virtual access point that is implemented in software in an environment of an electronic device or a computer. In addition, access points 114 and/or base station 116 may communicate with electronic devices 110 using wireless communication, while access points 114 and/or base station 116 may communicate with computer system 122 via network 124.

While not shown in FIG. 1, the wired and/or wireless communication with electronic devices 110 may further occur via an intranet, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

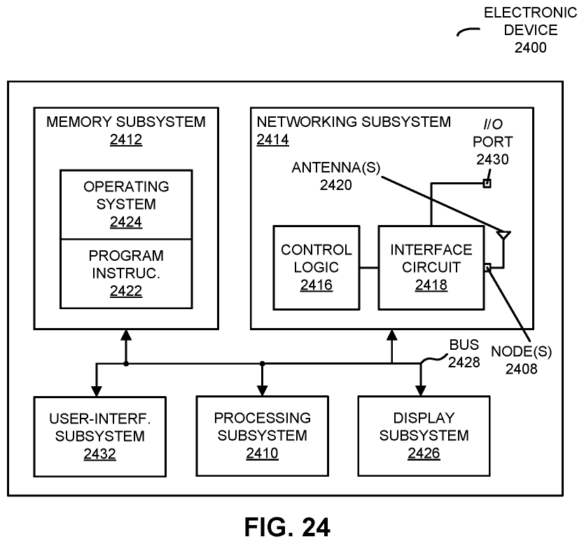

As described further below with reference to FIG. 24, electronic devices 110, access points 114, base station 116, and/or computers 120 may include subsystems, such as a networking subsystem, a memory subsystem and a processor subsystem. In addition, electronic devices 110, access points 114 and base station 116 may include radios 126 in the networking subsystems. More generally, electronic devices 110 and access points 114 can include (or can be included within) any electronic devices with the networking subsystems that enable electronic devices 110 and access points 114 to communicate with each other using wireless and/or wired communication. This wireless communication can comprise transmitting advertisements on wireless channels to enable access points 114 and/or electronic devices 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic devices 110 and access points 114, one or more of these instances may be different from the other instances of radios 126.

As can be seen in FIG. 1, wireless signals 128 (represented by a jagged line) are transmitted from radio 126-1 in electronic devices 110. These wireless signals may be received by radio 126-2 in access points 114. Notably, electronic devices 110 may transmit packets or frames. In turn, these packets or frames may be received by access points 114. Moreover, access points 114 may allow electronic devices 110 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic devices 110 and/or access points 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

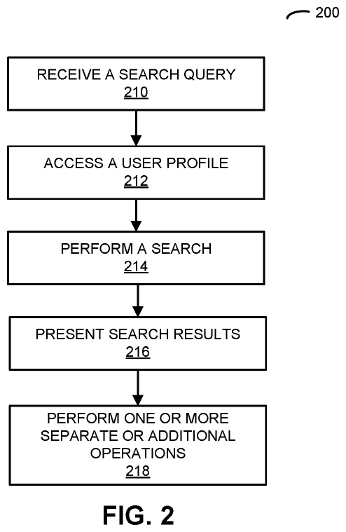

As discussed previously, it is often difficult to provide a high-touch real-estate service that scales and that is not time-consuming and inefficient. In order to address these problems, as described further below with reference to FIGS. 2-23, the search techniques may be used to provide different embodiments. For example, the search techniques may be used to provide a secure interactive virtual environment for identifying real-estate properties that are of interest. Notably, a user (such as a second individual) of electronic device 110-1 may provide a search query to a computer system (such as at least computer 120-1 in computer system 122). After receiving the search query, computer 120-1 may access a user profile, where the user profile includes information specifying real-estate interests of a first individual. The user profile may include real-estate elements that the first individual likes or dislikes (and, more generally, preferences), and the information may be expressed in an architectural language. Note that the first individual may be the same person as the second individual or may be a different person. For example, the second individual may be a relative of the first individual or an approved or authorized user of a common account or user profile with the first individual. Consequently, in some embodiments, the search techniques may allow joint (either separately or concurrently) searching and viewing of real-estate properties.

Moreover, computer 120-1 may perform the search of available real-estate properties based at least in part on the search query and the user profile. For example, computer 120-1 may generate a search expression (which includes synonyms and removed high-frequency or common words) based at least in part on the search query. Furthermore, the search query may include or may correspond to one or more identified real-estate properties that are of interest to the second individual. In these embodiments, the search query may include one or more attributes or characteristics of the one or more identified real-estate properties.

Then, computer 120-1 may determine match scores between the search expression and attributes or characteristics associated with available real-estate properties to identify search results (such as a top-N match scores, where N is an integer). Alternatively or additionally, the search query may be input to a pretrained machine-learning model along with the attributes or characteristics associated with the available real-estate properties, and the machine-learning model may output the search results.

In the present discussion, note that a pre-trained machine-learning model may have been trained using a machine-learning technique, such as a supervised-learning technique and/or an unsupervised-learning technique. For example, the supervised-learning technique may include: a classification and regression tree, a support vector machine (SVM), linear regression, nonlinear regression, logistic regression, least absolute shrinkage and selection operator (LASSO), ridge regression, a random forest, and/or another type of supervised-learning technique. Moreover, the unsupervised-learning technique may include a clustering technique. In some embodiments, the pre-trained machine-learning model may include a pre-trained neural network, such as a convolutional neural network or a recurrent neural network.

Next, computer 120-1 may present the search results, e.g., in a virtual environment, where the virtual environment includes an avatar corresponding to the first individual and a 3D representation of a real-estate property (such as a house, an apartment, a condominium, a building, or land), and the virtual environment allows the avatar to dynamically explore and view the real-estate property. Notably, computer 120-1 may provide information specifying the virtual environment to electronic device 110-1, where it is presented (e.g., displayed) to the second individual. In some embodiments, the virtual representation may present the real-estate property in a 3D context of a second environment that comprises the real-estate property. For example, the context may include: a building that comprises the real-estate property; and/or one or more buildings that are proximate to the real-estate property.

While exploring the real-estate property, the second individual may, via a user-interface device in electronic device 110-1 (such as a keyboard, a mouse, a trackpad, a stylus, a touch-sensitive display, a voice-recognition interface, a video camera, a motion sensor, a gaze-tracking device, etc.) provide feedback about the real-estate property. Then, computer 120-1 may receive the feedback about the real-estate property. In response, computer 120-1 may dynamically modify the user profile based at least in part on the feedback. Note that the dynamic modification may include translating the feedback into the architectural language used to express the information.

Moreover, the feedback may include a tag assigned to a real-estate element in the real-estate property by the second individual. Alternatively or additionally, the feedback may include second information specifying an emotional response of the second individual. For example, the second information may include one or more images of the second individual, and the one or more images may include: a gesture, a facial expression, body motion, and/or body language of the second individual; or natural language of the second individual. In some embodiments, the dynamic modification may be performed by a pretrained supervised-learning model (such as a machine-learning model or a neural network). Additionally, computer 120-1 may retrain the pretrained supervised-learning model based at least in part on the modified user profile.

Note that the user profile may be uniquely associated with the first individual. For example, the user profile may be uniquely tied to the first individual using a blockchain. In some embodiments, the 3D representation of the real-estate property may be generated using a second pretrained supervised-learning model (such as a machine-learning model or a neural network).

Alternatively or additionally, after or while performing the search, computer 120-1 may analyze the available real-estate properties to assess a need, ability and/or suitability for modification based at least in part on the user profile and the search query. For example, the user profile may indicate (directly or indirectly) a preference for a real-estate element, such as French doors from a living room to a garden. Computer 120-1 may assess a need for such a modification (e.g., whether or not a real-estate property has the real-estate element), an ability to make the modification (e.g., based at least in part on zoning regulations and/or architectural plans of the real-estate property), an estimated cost of the modification and/or an estimated time needed to complete the modification. The search results may be filtered by one or more of these factors. Notably, computer 120-1 may filter search results to exclude a subset of the available real-estate properties that are unable to be modified, or for which an estimated time and/or an estimated cost of modification exceeds predefined threshold values (such as 1, 3 or 6 mo. or $10 k, $25 k or $50 k). Then, computer 120-1 may present the filtered search results by providing the filtered search results to electronic device 110-1.

In some embodiments, the real-estate property may be presented with a simulation of the modification in the virtual environment. For example, the virtual environment may include a predefined architectural, landscape or interior design and the 3D representation of the real-estate property is modified from an existing state of the real-estate property based at least in part on the predefined architectural, landscape or interior design. The modified 3D representation of the real-estate property may be presented using a hologram. Moreover, computer 120-1 may print or generate a 3D model of the modified 3D representation of the real-estate property (e.g., using a 3D printer). Furthermore, computer 120-1 may provide a recommendation for a contractor to modify an existing state of the real-estate property (e.g., based at least in part on the modification).

More generally, in other embodiments, computer 120-1 may filter the search results to exclude a subset of the available real-estate properties based at least in part on a variety of factors, such as: security settings associated with the available real-estate properties in the subset (such as a security setting to only show a real-estate property to prospective buyers or prospective buyers who are prequalified to purchase the real-estate property or real-estate properties having comparable prices, viewers who currently own another real-estate property, another type of viewer, or all viewers, including a casual viewer that is not planning to purchase or make an offer for the real-estate property); a history of searches and/or search behaviors of the first individual and/or the second individual (such as previously presented real-estate properties or real-estate properties that were viewed); an estimated security risk associated with the first individual and/or the second individual (such as based at least in part on prior complaints about or a criminal history of the first individual and/or the second individual, and/or which may be computed based at least in part on the user profile); a purchasing state associated with the first individual and/or second individual (such as whether or not either of the they are a prospective buyer, are prequalified, and/or whether or not either or both currently own a real-estate property); estimated costs associated with real-estate elements (such as the estimated cost of types of materials in the real-estate elements, which are preferred by the first individual and/or the second individual in, e.g., the user profile); preferences of the first individual and/or second individual (such as real-estate elements in the user profile and, more generally, based at least in part on the user profile); and/or an approved purchasing capability associated with the second individual (such as a mortgage prequalification, a credit history and/or a financial history). Note that estimated values in the search techniques may be computed by a pretrained supervised-learning model (such as a machine-learning model or a neural network).

In some embodiments, computer 120-1 may perform one or more operations to maintain security in the virtual environment and the real-estate properties that are viewed in the virtual environment. For example, when the second individual has a virtual tour or viewing of the real-estate property, computer 120-1 may log or store information indicating that there was virtual access, by the second individual, to the real-estate property. Subsequently, in response to a request associated with the logged virtual access (e.g., from or associated with an authorized requestor, such as an owner of the real-estate property, a renter of the real-estate property, law enforcement or a government agency), computer 120-1 may selectively provide information specifying or identifying the second individual. For example, the request may be provided to computer 120-1 when there is an occurrence of an event (such as a crime proximate to or in the real-estate property).

Alternatively or additionally, during a virtual tour, computer 120-1 may obfuscate or remove secondary information (such as sensitive or personal information, security information, etc.) associated with the real-estate property in the 3D representation of the real-estate property based as least in part on: a security setting associated with the real-estate property (which may, directly or indirectly, specify the secondary information); a history of searches and/or or search behaviors associated with the first individual and/or the second individual); and/or the search results. Note that the secondary information may include security information, such as information about an alarm system (e.g., presence or absence of an alarm system, a type of the alarm system, coverage of an alarm system, etc.), a lock, and/or a security camera (e.g., presence or absence of a security camera, a type of security camera, coverage associated with a security camera, etc.).

In these ways, computer system 122 may provide a secure interactive virtual environment in which one or more individuals can perform searches for real-estate properties. Thus, the search techniques may automate aspects of the search process. Consequently, the search techniques may reduce the time and effort, as well as the expense, of identifying real-estate properties that are of interest. This may include real-estate properties that do not, at least in their current form, yet exist. Therefore, the search techniques may improve the user experience, which may increase commercial activity.

While the preceding embodiments illustrated the search techniques being implemented via a cloud-based computer system 122, in other embodiments at least some of the aforementioned operations may be performed locally on, e.g., one of electronic devices 110. Thus, operations in the search technique may be performed locally or remotely.

We now describe embodiments of a method. FIG. 2 presents a flow diagram illustrating an example of a method 200 for performing a search, which may be performed by a computer system, such as one or more computers 120 in computer system 122 (FIG. 1). During operation, the computer system may receive a search query (operation 210) associated with a second individual. This search query may include or may correspond to or specify an identified real-estate property that is of interest to the second individual.

Then, the computer system may access a user profile (operation 212), where the user profile includes information specifying real-estate interests of a first individual. Note that the first individual may be different from the second individual. For example, the first individual and the second individual may be related (such as two friends, a couple in a relationship or a married couple). Moreover, the user profile may include real-estate elements that the first individual likes or dislikes, and the information may be expressed in an architectural language.

Furthermore, the computer system may perform the search (operation 214) of available real-estate properties based at least in part on the search query and the user profile.

Next, the computer system may present search results (operation 218), e.g., in a virtual environment, where the virtual environment includes an avatar corresponding to the first individual and a 3D representation of a real-estate property (such as a house, an apartment, a condominium, a building, or land), and the virtual environment allows the avatar to dynamically explore and view the real-estate property.

In some embodiments, the computer system optionally performs one or more separate or additional operations (operation 218). For example, the computer system may: receive feedback about the real-estate property (such as from the first individual and/or the second individual); and dynamically modify the user profile based at least in part on the feedback. Note that the dynamic modification may include translating the feedback into the architectural language used to express the information.

Moreover, the feedback may include a tag (with a positive or a negative association) assigned to a real-estate element in the real-estate property by the second individual. Alternatively or additionally, the feedback may include second information specifying an emotional response of the second individual. For example, the second information may include one or more images of the second individual, and the one or more images may include: a gesture, a facial expression, body motion, and/or body language of the second individual; or natural language of the second individual. In some embodiments, the dynamic modification may be performed by a pretrained supervised-learning model (such as a machine-learning model or a neural network). Additionally, the computer system may retrain the pretrained supervised-learning model based at least in part on the modified user profile.

Furthermore, the virtual representation may present the real-estate property in a 3D context of a second environment that comprises the real-estate property. For example, the context may include: a building that comprises the real-estate property; and/or one or more buildings that are proximate to the real-estate property.

Additionally, the user profile may be uniquely associated with the first individual. For example, the user profile may be uniquely tied to the first individual using a blockchain.

In some embodiments, the 3D representation of the real-estate property may be generated using a second pretrained supervised-learning model (such as a machine-learning model or a neural network). Moreover, the 3D representation of the real-estate property is modified from an existing state of the real-estate property based at least in part on the user profile. For example, the virtual environment may include a predefined architectural, landscape or interior design and the 3D representation of the real-estate property is modified from an existing state of the real-estate property based at least in part on the predefined architectural, landscape or interior design. The modified 3D representation of the real-estate property may be presented using a hologram. Furthermore, the computer system may print or generate a 3D model of the modified 3D representation of the real-estate property (e.g., using a 3D printer). Furthermore, the computer system may provide a recommendation for a contractor to modify an existing state of the real-estate property (e.g., based at least in part on the modification).

Alternatively or additionally, after or while performing the search (operation 214), the computer system may analyze the available real-estate properties to assess a need, ability and/or suitability for modification based at least in part on the user profile (such as real-estate elements that the first individual likes or dislikes, and associated estimated costs associated with the real-estate elements, such as a type of material) and the search query. Furthermore, the computer system may filter search results to exclude a subset of the available real-estate properties that are unable to be modified, or for which an estimated time and/or an estimated cost of modification exceeds predefined threshold values. However, in other embodiments, the computer system may filter the search results to exclude a subset of the available real-estate properties based at least in part on: security settings associated with the available real-estate properties in the subset; a history of searches and/or search behaviors of the first individual and/or the second individual; an estimated security risk associated with the first individual and/or the second individual (which may be computed based at least in part on the user profile); a purchasing state associated with the first individual and/or second individual (such as whether or not the first individual and/or the second individual are prequalified buyers, currently own another real-estate property and/or is a casual viewer that is not planning to purchase or make an offer for the real-estate property); estimated costs associated with real-estate elements; preferences of the first individual and/or second individual; and/or an approved purchasing capability associated with the first individual and/or the second individual (which may correspond to a financial history associated with the first individual and/or the second individual, such as an approved range of mortgages, a credit history, etc.). Note that a given security setting may specify an allowed type of viewer, such as when the first individual or the second individual is a prequalified buyer, currently own another real-estate property and/or is a casual viewer that is not planning to purchase or make an offer for the real-estate property. Additionally, the computer system may present the filtered search results (operation 216).

In some embodiments, the computer system logs virtual access, by the second individual, to the real-estate property. Subsequently, in response to a request associated with the logged virtual access (e.g., from or associated with an authorized requestor, such as: an owner of the real-estate property, a renter of the real-estate property, law enforcement or a government agency), the computer system may selectively provide information specifying or identifying the second individual. For example, the request may be based at least in part on an occurrence of an event, such as a crime proximate to or in the real-estate property. Alternatively or additionally, the computer system may obfuscate or remove secondary information (such as sensitive or personal information, security information, etc.) associated with the real-estate property in a 3D representation of the real-estate property based as least in part on: a security setting; a history of searches and/or or search behaviors; and/or the search results. Note that the secondary information may include security information, such as information about an alarm system (e.g., presence or absence of an alarm system, a type of the alarm system, coverage of an alarm system, etc.), a lock, a security camera (e.g., presence or absence of a security camera, a type of security camera, coverage associated with a security camera, etc.).

In some embodiments of method 200, there may be additional or fewer operations. Furthermore, the order of the operations may be changed, there may be different operations and/or two or more operations may be combined into a single operation. Note that estimated values in method 200 may be computed by a pretrained supervised-learning model (such as a machine-learning model or a neural network).

We now further describe the search techniques. In generally, the search techniques may leverage the characteristics of gameplay learning machines and dynamic adoption of personalities. A computer system (which is sometimes referred to as a ‘real-estate system’) may provide a platform in which users learn basic, intermediate, and/or advanced real-estate concepts in a fun, accessible gaming environment, and are connected with or referred to real-estate professionals who can turn their virtual real-estate dreams into life-changing realities using APL-driven game environments.

Note that search results may be presented in a gallery or as a 3D model (with different perspectives). In some embodiments the search results may be presented in context, such as a physical location relative to the surroundings (e.g., the environment that includes a condominium on a particular floor of a building may be presented in 3D, including the building and neighboring buildings). Moreover, the search results may include avatar behavioral hysteresis, which defines how an avatar converges on a solution for a search request.

In some embodiments, search results may be shared on social media, so that people can click a link and view a property via the real-estate system (if needed, a new viewer may first create a user profile and may authenticate). Alternatively, users (such as a family) may jointly use the real-estate system (e.g., from different locations). In some embodiments, the real-estate system may allow realtors to conduct a weekly professional tour of available properties for other realtors.

The real-estate system may learn and adapt to a user as a user plays and can translate this learning to the real world with factual results. Moreover, a user may tag properties or attributes or elements of properties that are of interest (or not) to assist the real-estate system in this learning.

Furthermore, the real-estate system may create an avatar that represents the user, e.g., based at least in part on APL desires in a user profile. Note that an avatar may provide a digital icon or character that represents a way of looking at the APL world from a unique position or perspective associated with a user. In some embodiments, users may trading avatars and/or merge avatar capabilities. Note that the real-estate system may provide privacy protection of avatars. Blockchain is one approach, but other options may be used.

An avatar may be able to understand the architectural elements, patterns language (APL), e.g., of a Craftsman house. An avatar may be able to suggest changes that could turn one type of property into another. The avatar may understand and use an APL.

Moreover, an avatar may be capable of designing or generating new architectures. Thus, the real-estate system may be used to connect users to contractors, interior designers, landscapers and architects. For example, the real-estate system may provide a platform that enables a marketplace in which interior designers, landscapers and architects license designs for use in particular environments or residences, and/or contractors may bid to implement changes desired by a user. The environment provided by the real-estate system may allow a user to explore or visualize (using augmented or virtual reality) different views of different designs.

Alternatively or additionally, the real-estate system may be used for generative (semi or fully automated) design. Note that generative design is a relatively new concept in architecture that is becoming more common as more firms integrate machine learning into their design processes. What makes our use of generative design unique is the potential of our architectural data structure or database. Our avatars will have access to a visual data structure or database of massive amounts of exterior and interior designs, and the foundational understanding of APL to identify the distinct patterns present in every structure that is added to the data structure or database, deconstruct those patterns, and find more efficient, unique, and novel uses for them, within the constraints of the local building/planning regulations and location-specific conditions (or user specifications). Our goal is to ‘scan the world,’ so that the patterns of the world's architecture may be available for the real-estate system to draw upon to create these potentially novel designs.

Note that the generative design may find properties than can be retrofit or modified with a particular budget constraint or price. For example, a retrofit that requires structural changes to a property may be expensive. The real-estate system can analyze images or a model of a property to determine how much it will cost to be retrofitted; can link to contractors or architects; or can link to libraries of copyrighted designs that are for sale. These libraries may be automatically updated based at least in part on changes to building codes, zoning codes, or other codes.

This approach may also modernize inspection by allowing it to be conducted in a virtual or augmented reality environment. This may remove bottlenecks and reduce the cost of inspection.

The real-estate system may allow a user to perform a curiosity-based search to, e.g., see what properties are out there or are currently available in a region. This capability may allow users to learn about a real-estate market even before they are interested in purchasing or investing in a property. This may also allow the real-estate system to learn what a user likes or dislikes (as opposed to having a user explicitly indicate what they like or dislike, e.g., in their user profile). In some embodiments, such users may be restricted to viewing virtual or fictional properties.

More generally, the real-estate system may allow a user to perform dynamic, visual searches for properties that are potentially of interest. These searches may be based at least in part on or may use a trained avatar of a user, which identifies a given property based at least in part on elements (such as real-estate elements, attributes and/or characteristics) associated with the given property. Moreover, when a current property of interest is identified, this real-estate property may be used to identify other similar properties that share elements or attributes with the current property. Note that the real-estate system may be trained using the language and principles of architecture. Thus, even when a user likes something, but doesn't know why (or doesn't have the language to describe or explain why), the real-estate system can leverage its knowledge to find similar properties or properties that have similar elements.

The avatars may understand people's desires/patterns using the architectural language based at least in part on APL. This is not 3D, color or other real-estate elements that are too specific, but is a more basic and broad understanding that can translate into other homes, residences or spaces that are different but follow the APL that a user found pleasing or desirable.

Note that an avatar can associate a user's emotions with architectural desires and provide suggestions for homes based at least in part on this, e.g., a home with more light to reduce depression, and/or other APL(s) can be used to this effect.

In some embodiments, the real-estate system may be used for financial planning. An avatar may identify a problem and may provide a solution with insight into financial situations and may suggest pathways that are the most advantageous, while maintaining the user's best interests.

Moreover, security in the real-estate system may be provided by maintaining a log of users that view particular properties. In addition, sensitive details associated with a property (such as security systems) may be obfuscated. Alternatively, only pre-qualified buyers or approved potential buyers may be allowed to view a given real-estate property or areas within or about real-estate properties.

### The Structure of Pattern Languages and A Pattern Language

A pattern language may include a language that links patterns together. More specifically, there are relationships between patterns and science, language, information, structure, and changes in time and design. Moreover, at a high level, in designing one's environment, people often rely on certain “languages,” such as those that allow them to articulate and communicate their designs. These design patterns can be combined in an infinite number of ways. Notably, some examples of coupling include: one pattern that contains or generalizes another smaller-scale pattern; two patterns that are complementary, where one needs the other for completeness; two patterns that solve different problems and that overlap and coexist on the same level; two patterns that solve the same problem in the alternative, equally valid ways; and/or distinct patterns that share a similar structure, thereby implying a higher-level connection.

In the context of architecture, a pattern language may include details such as: the connective geometry of urban interfaces, reversing pattern orders, validation of a pattern, patterns and science, the nature of a pattern language, hierarchical connections, consistency and connectivity, stylistic rules, evolution, and/or repair of pattern languages, and the importance of detail. In summary, pattern languages may apply to nearly everything, from computer programs to mathematics, to buildings, to organizations, and to cities. In general, patterns may provide the necessary framework for any design solution to connect with a human and have drastic effects on architectural practice.

### Natural Language Processing

Natural Language Processing (NLP) explores how computers can be used to understand and manipulate natural language text or speech for a specific reason. NLP applications include machine translation, natural language text processing, user interfaces, digital libraries, artificial intelligence/machine-learning (AI/ML) systems, etc. NLP often starts with morphological analysis at the word level, then progresses to the sentence level, and then to the context and overall environment. Statistical NLP is often strongly focused on the use of deep learning neural networks for inference, developing robust end-to-end systems, and/or aiding in challenging problems in NLP.

### 3D Avatars in the Gaming Industry

An AI avatar, or digital avatar, is AI-powered and may use NLP techniques, image recognition technology, augmented reality/virtual reality (AR/VR), and/or animation technologies to communicate with, e.g., users/gamers. A few of the uses for digital avatars include: virtual assistants, gaming, mobile communication, and/or training. Companies such as Pinscreen, Inc. (of Los Angeles, Calif.) have launched avatar software development kits (SDKs), stylized avatars, virtual assistants, face trackers, etc.

### AI in Gaming

AI in gaming refers to responsive and adaptive gaming experiences aimed at enhancing a player's experience. AI-powered interactive experiences may be generated via non-player characters (NPCs) that act intelligently, so that they act as if they are being controlled by a human game player.

### Behavioral Analysis of Home Buyers and Purchases

Common factors affecting home buying include: financial factors, economic factors, construction quality, and belief factors. Of these factors, financial factors are typically given the highest consideration. Other detailed factors when buying a home, include: financing factors (such as loan interest rates and house price), distance factors (such as distance to markets, schools, etc.), developer factors (such as who developed the home), superstition factors (such as numbers and ghosts), environmental factors (such as noise, traffic, and/or pollution), house feature factors (such as quality and size), and living space factors (such as a number of bedrooms and bathrooms, number of stories, etc.) The five variables that appear to be of most importance when purchasing a home include: financing, distance, superstition (numbers), environment, and house features.

The disclosed real-estate system may allow real-estate professionals to better serve their clients, but may also allow a real-estate professional to address the needs and/or desires of their clients without significant limitation. These needs and desires may be: emotional, fleeting, changing over time or dynamic, nuanced, etc. These capabilities may allow the real-estate professionals to meet and satisfy their clients' needs. Simultaneously, clients would like to find a property that will meet all of their needs. Notably, a client may explain to a real-estate professional what they are looking for with their limited tools and capabilities. The disclosed real-estate system may allow people/clients to train an avatar/machine-learning-based representation of themselves to find their ideal property by learning and understanding the needs and desires of these clients. In some embodiments, the real-estate system is implemented locally (e.g., in software or an application that executes on a computer or an electronic device) and/or remotely (e.g., in cloud-based computer or computer system, which may be accessed in a client-server architecture). Note that, when someone demonstrates skill and taste in their selection of objects or properties in their life, we may wish to duplicate their approach and ask them to find us new properties or a new place to live, a new desired object, etc. The disclosed real-estate system may formalize this process, thereby allowing clients to benefit from the capabilities of such talented professionals.

Moreover, at the core of the challenge facing real-estate professionals and buyers of property is finding not just any property, but the ‘right’ property. Buyers do not always know what they want, and they do not always know how to communicate their wants and needs to the real-estate professional who will help them in their search. The disclosed real-estate system may assist buyers in learning what they want by dynamically interacting with their avatar and virtually touring a large number of real-estate properties. This process may expand the buyers' experiences and understanding of the built environment and broaden the types of buyers.

Furthermore, investing in real estate is one of the most accessible ways to build wealth in the United States and elsewhere. For people who understand how the real-estate industry works, there are many ways to create wealth-generating opportunities. This knowledge is typically in the hands of experienced investors and professionals, which generally limits opportunities to this group of people. The disclosed real-estate system may democratize this investment process, so that a larger and more-diverse group of individuals may identify opportunities in real-estate.

This disclosure (among other things) enables buyers (such as home buyers) to explore properties via machine-learning avatars. In the process, the avatars in the real-estate system may learn not just what the purchasers of property want, but more importantly why they want it. Once the real-estate system understands the intentions or motivations of a buyer, their avatar can show them how to get what they want in a significantly more efficient/less time-consuming and more effective manner than existing approaches.

### Architectural Pattern Language

In the present disclosure, the pattern language that is used may, at least in part, be based at least in part on human experiences (such as over the hundreds to thousands of years). The more-common language patterns may include patterns that are more pleasing to humans and may not need to extend past the scope of human usage. In some embodiments, the APL may include one or more of the items shown in Table 1.

TABLE 1

| | The distribution of | | |
|---|---|---|---|
| Independent regions | towns | City county fingers | Agricultural valleys |
| Lace of County Streets | Country towns | The Countryside | Mosaic of subcultures |
| Scattered work | Magic of the city | Local transport areas | Community of 7000 |
| Subculture boundary | Identifiable | Neighborhood | Web of public |
| | neighborhood | boundary | transportation |
| Ring roads | Network of learning | Web of shopping | Mini-bus |
| Four-story limit | Nine percent parking | Parallel roads | Sacred sites |
| Access to water | Life cycle | Men and women | Eccentric nucleus |
| Density rings | Activity nodes | Promenade | Shopping street |
| Night life | Interchange | Household mix | Degrees of publicness |
| House cluster | Row houses | Housing hill | Old people |
| | | | everywhere |
| Work community | Industrial ribbon | University as a | Local town hall |
| | | marketplace | |
| Necklace of community | The market of many | Health center | Housing In between |
| projects | shops | | |
| Looped local roads | T junctions | Green streets | The network of paths |
| | | | and cars |
| Main gateways | Road crossing | Raised walk | Bike paths and racks |
| Children in the city | Carnival | Quiet backs | Accessible green |
| Small public square | High places | Dancing in the street | Pools and streams |
| Birth places | Holy ground | Common land | Connected play |
| Public outdoor room | Grave sites | Still water | Local sports |
| Adventure playground | Animals | The family | House for a small |
| | | | family |
| House for a couple | House for one person | Your own home | Self-governing |
| | | | workshops and |
| | | | offices |
| Shopfront schools | Children's home | Individually owned | Street cafe |
| | | shops | |
| Corner grocery | Beer hall | Traveler's inn | Bus stop |
| Food stands | Sleeping in public | Building complex | Number of stories |
| Shielded parking | Circulation realms | Main buildings | Pedestrian street |
| Building thoroughfare | Family entrances | Small parking lots | Site repair |
| South facing outdoors | Positive outdoor space | Wings of light | Connected buildings |
| Long thin house | Main entrance | Half-hidden garden | Entrance transition |
| Car connection | Hierarchy of open space | Courtyards which live | Cascade of roofs |
| Sheltering roof | Roof garden | Arcades | Paths and goals |
| Path share | Building fronts | Pedestrian density | Activity pockets |
| Stair seats | Something roughly in | Intimacy gradient | Indoor sunlight |
| | the middle | | |
| Common areas at the | Entrance room | The flow-through | Short passages |
| heart | | rooms | |
| Staircase as a stage | Zen view | Tapestry of light and | Couple's realm |
| | | dark | |
| Children's realm | Sleeping to the East | Farmhouse kitchen | Private terrace on the |
| | | | street |
| A room of one's own | The sequence of sitting | Bed cluster | Bathing room |
| | spaces | | |
| Bulk storage | Flexible office space | Communal eating | Small work groups |
| Reception welcomes you | A place to wait | Small meeting rooms | Half-private office |
| Rooms to rent | Teenager's cottage | Old age cottage | Settled work |
| Home workshop | Open stairs | Light on two sides of | Building edge |
| | | every room | |
| Sunny place | North face | Outdoor room | Street windows |
| Opening to the street | Gallery surround | Six-foot balcony | Connection to the |
| | | | Earth |
| Terraced slope | Fruit trees | Tree places | Garden growing wild |
| Garden wall | Trellised walk | Greenhouse | Garden seat |
| Vegetable garden | Compost | Alcoves | Window place |
| The fire | Eating atmosphere | Working enclosure | Cooking layout |
| Sitting circle | Communal sleeping | Marriage bed | Bed alcove |
| Dressing room | Ceiling height variety | The shape of indoor | Windows |
| | | space | overlooking life |
| Half-open wall | Interior windows | Staircase volume | Corner doors |
| Thick walls | Closets between rooms | Sunny counter | Open shelves |
| Waist-high shelf | Built-in seats | Child caves | Secret place |
| Structure follows social | Efficient structure | Good materials | Gradual stiffening |
| spaces | | | |
| Roof layout | Floor and ceiling layout | Thickening the outer | Columns at the |
| | | walls | corners |
| Final column distribution | Root foundation | Ground floor slab | Box columns |
| Perimeter beams | Wall membranes | Floor-ceiling vaults | Roof vaults |
| Natural door and | Low sill | Deep reveals | Low doorway |
| windows | | | |
| Frames as thickened | Column place | Column connection | Stair vault |
| edges | | | |
| Duct space | Radiant heat | Dormer windows | Roof caps |
| Floor surface | Lapped outside walls | Soft inside walls | Windows which open |
| | | | wide |
| Solid doors with glass | Filtered light | Small panes | Half-inch trim |
| Seat spots | Front door bench | Sitting wall | Canvas roofs |
| Raised flowers | Climbing plants | Paving with cracks | Soft tile and brick |
| | | between the stones | |
| Ornament | Warm colors | Different chairs | Pools of light |
| Red tape | | | |

Please note that, in some embodiments, other pattern languages may be used, but it is often useful to use a pattern language that is one based at least in part on an architectural design, that includes interior, exterior, and landscape design patterns, and/or that is consistent and has been used for a long time in design. Note that the list in Table 1 is not exhaustive and may include other terminology associated with modern interior and exterior structural design and materials.

### Data Structure or Database Makeup

In addition to the disclosed virtual environment, and in order for human pattern languages to be used, there may need to be a layer of a pattern language that distinctly articulates the given space/environment. The ‘world database (or data structure) makeup’ may refer to a virtual world mapped and defined in the same architectural and environmental pattern language used for the human pattern language.

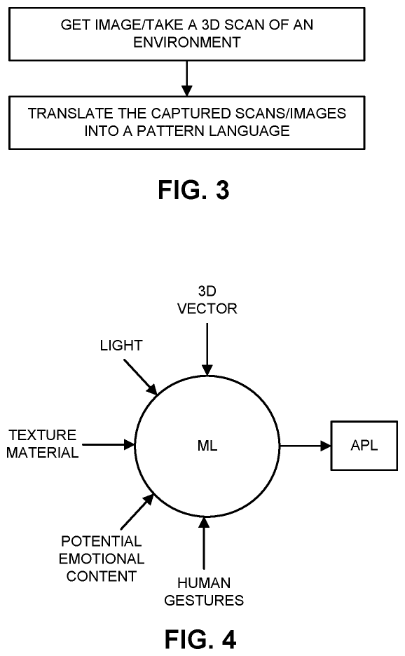

As shown in FIG. 3, which presents a drawing illustrating an example of generating a world data structure or database using a pattern language, this may involve scanning a 3D environment and considering components, such as light, time of day, air quality, etc. (While 3D is used as an illustration in the present discussion, more generally 2D, 2.5D and/or holography may be used instead of or in conjunction with 3D). Note that 3D may include spatial parallax, motion parallax, and/or prehension.) The scanned images and components may be translated into a pattern language using a hierarchical technique, starting with furniture within a space, rooms within a space, space within a building, buildings within a city, etc. While the pattern language may narrow the number of ways to define a particular space, there may be an infinite number of combinations.

Existing technology may allow us to generate detailed 3D depictions of our planet including real estate, but also everything else. Examples include Google maps (from Alphabet, Inc. of Mountain View, Calif.) and some game technologies. These 3D depictions of our world are usually graphically based with limited or no language support. In the disclosed real-estate system, these detailed 3D depictions may be mapped/translated into APL. In some embodiments, the mapping may be performed by a pretrained ML model that receives 3D depictions and other environmental detail as inputs and produces the APL depiction as an output. Note that in some embodiments other program languages besides or in addition to APL may be used. Moreover, in some embodiments, a given ML model or layer in the present disclosure may include a classifier or a regression model that was trained using: a support vector machine technique, a classification and regression tree technique, logistic regression, LASSO, linear regression, a neural network technique (such as a convolutional neural network technique, a generative adversarial network or another type of neural network technique) and/or another linear or nonlinear supervised-learning technique. In some embodiments, the given ML model or layer can render an APL model in 3D or 4D (such as 3D image(s) as a function of time). Thus, for a particular real-estate property (such as one that has been scanned), the given ML model or layer may generate an architectural rendering.

As shown in FIG. 4, which presents a drawing illustrating an example of mapping 3D depictions into an APL, note that human emotions and body language (such as gestures) may be captured or included in APL. However, the translation may not be one-to-one and may be performed in context and related to culture and descriptions associated with the 3D and environmental models in the same stream of input data to this ML. In the present disclosure, this ML layer is sometimes referred to as ‘3D+toAPL’ to distinguish it from other ML layers in the real-estate system.

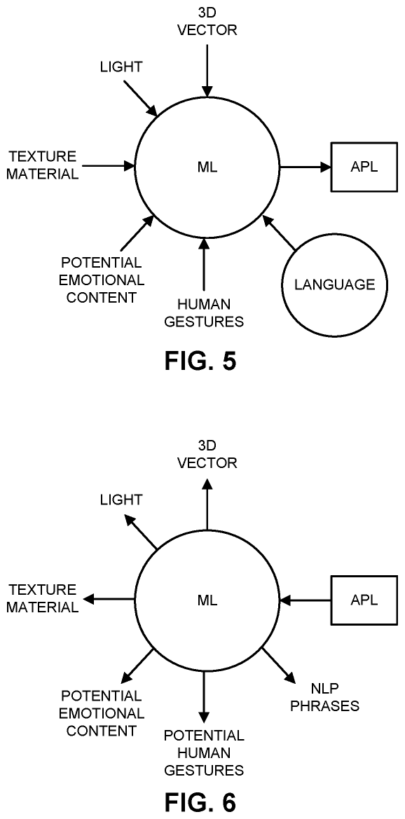

In some embodiments, a second data structure or database depicting spoken language patterns translated to APL may be used to train another layer of the ML. The resulting ML layer may be a combination of 3D+APL and an additional NLP parser, e.g., with voice analysis, to identify potential emotional content. Because the real-estate system expects spoken language to be in the presence and context of a 3D environment, the real-estate system can generate an efficient way to train the ML model using both languages and the other 3D+toAPL inputs to map the spoken language description and emotions and gestures with the 3D-environmental detail into a correct (or at least highly likely) APL pattern. For example, client A may say “I like the openness of this kitchen, and the way it flows into the living room.” The ML may recognize this as “like” as (approval) “openness” as an APL concept, “flows” as an APL concept, and “living room” as an APL concept. Then, the system may search a 3D data structure to find properties that offer similar characteristics and/or the potential to create similar characteristics. FIG. 5 presents a drawing illustrating an example of mapping NLP 3D to APL.

Additionally, the real-estate system may include an ML module or subsystem, which is being trained, to be able to take APL and generate 3D-environmental depiction and NLP phrases and human gestures that are closely related. For simplicity, the real-estate system may mark this ML layer as APLto3D+NLP, as shown in FIG. 6, which presents a drawing illustrating an example of mapping APL to NLP and 3D.

Similarly, the real-estate system may train the first and the second ML layers to receive APL and to generate the closest 3D-environmental depiction to this APL description. The real-estate system may expect it to generate NLP phrases that can help us in conversations with a client. Note that this operation may not be a reverse or an inverse of the previous two ML layers, but an additional layer that is being added, which has a different scope. One can consider this as a basis for a search engine for APL-based environments. In the discussion that follows, we refer to this capability as ‘APLto3D+NLP.’

In some embodiments, a financial data structure or database may be added into the real-estate system. The financial data structure or database may map some or all of the APL elements and their specific aspects (such as potential materials, number of man hours to construct or demolish, measurements, etc.) into a cost range potential. This may be an APLtoFin that is generated by a ML layer that takes as inputs an NLP and its aspects, location, and relations to other connected NLPs and financial models attached to these NLP elements, and outputs a cost estimate range.

### Architectural Pattern Language Elements

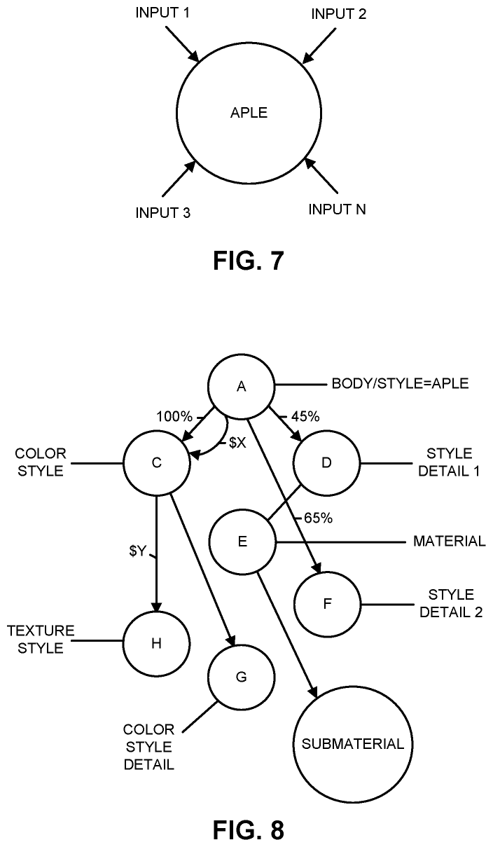

FIG. 7 presents a drawing illustrating an example of N features (or inputs) that modify APL elements (APLE), where N is a non-zero integer. For example, if an element or APLE is for roofing shingles, the inputs may include characteristics/features that affect and are related to the element, such as material type, color, size, weight, pattern, profile, texture, brand, etc. This information may provide the understanding that a node (in this case, the APLE) can be part of a complicated graph structure that represents a complete architecture structure.

With this discussion in mind, we can define the following definitions. architecture (A): a complicated or carefully designed structure of something; pattern (P): a regularity in the world, in human-made design, or in abstract ideas, which often includes the elements of a pattern repeat in a predictable manner; language (L): a structured system of communication used by humans, including speech, gestures and/or writing; element (E): a part or aspect of something abstract, especially one that is essential or characteristic; neuron: an APLE (such as a roof, a door, a frame, etc.); phenotype: a connected group of neurons/elements that is an APLE with its associated depicted complexity; and synapses: feature or characteristics further describing or augmenting an element and connecting two neurons.

Using these definitions, we can characterize the data structures or databases and ML models or techniques that operate on these data structures or databases, as well as how to create these data structures or databases.

### APLE as a Complicated Neural Network

As shown in FIG. 8, which presents a drawing illustrating an example of an APLE neural network, the neural network may include features associated with a specific APLE (e.g., color, texture, material, etc.). When these synapses and neurons are grouped together, it may provide or create an architectural pattern or a phenotype. This phenotype may connect the group of neurons, or in this case, it may be a connected group of APL elements. Note that this may be dependent on weights and elements. For example, there can be multiple sub-features or sub-details in the type of element (e.g., a roof with multiple levels, colors, panel types, etc.), and the sizes, colors, levels, and details may build up a complicated data structure or database with features/characteristics related to a specific element. This data structure or database may have nearly endless possibilities in terms of the various structures and combinations of elements and their features that can be created.

FIG. 8 illustrates an APLE phenotype as a connected graph in which every node/neuron is an APL element and arrows/synapses are characteristics and their weights added into or coming out of a neuron. Moreover, every neuron may be considered as a root of its own tree, and by adding children the real-estate system increasingly adds detail to the characteristics of this APL subtree. For example, in order to build a basic financial model, the real-estate system may divide or separate the tree into its separate neurons and sum the subtree value where this neuron is the root. This principle may be a simple or naive way for determining the cost or the financial model. A second operation may be required with ML in order to understand every node in its environment and/or its surrounding (neighboring nodes) and adjust the numbers accordingly. In general, this operation typically cannot be performed manually because it is adjusted dynamically as the model evolves. This is also the reason for the data structure that maintains the relationships, so that the real-estate system can trace (e.g., using ML) the environment that takes it into consideration when creating an arbitrary model based at least in part on this phenotype. Note that the usefulness of this model will be discussed further below as we add more information into the model.

### APLE+NLP Neural Network

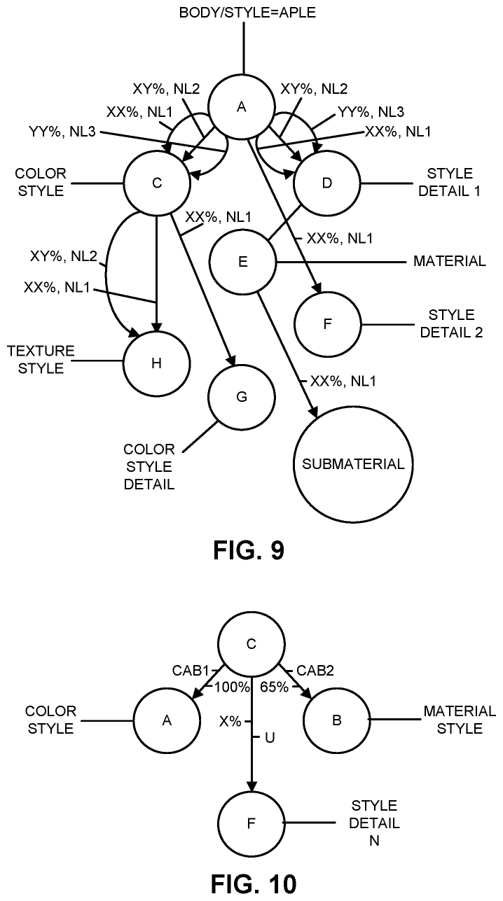

In order to understand what in the language results in a given APLE, we first structure the APLE neural network and overlay it with words that lead from one node to another. There can be several phrases that describe a common NLP element, e.g., phrases relating to a roof and what weight or probability we are interested in for this specific input/node. This also allows the real-estate system to better formulate questions in order to obtain the appropriate level of detail associated with that specific ALPE. FIG. 9 presents a drawing illustrating an example of an NLP and APL neural network, including the concept of several natural phrases (NLs) relating to a common node. Note that, in general, the number of NLs can be unlimited.

In FIG. 9, the NLP vocabulary may be linked to an APL structure. In turn, this may allow us to understand clearly how vocabulary leads to APL sub-elements and how, using language, the real-estate system builds this architecture. Moreover, the percentage attached to a given synapse may demonstrate or indicate the probability of this word/phrase being used in connection with the receiving node to describe it or to lead into it being used within the overall phenotype. Thus, in some embodiments, 3D modeling may occur via voice command or input.

### APLE+Financials Neural Network

As illustrated in Table 2, which shows an example of an element and feature pricing data structure or database for a kitchen remodel, part of the real-estate system may include a data structure or database that associates elements with prices. Notably, a given feature of an element may have an associated base price (e.g., granite vanity versus wood vanity). This base price may be manipulated or modified based at least in part on the location of the home. The feature price may be represented in between the nodes. A naive way of calculating this is by multiplying these nodes by their weights and then adding the features and elements together (e.g., using a weighted linear superposition). Moreover, as shown in FIG. 10, which presents a drawing illustrating an example of feature and node connections, the synapses may point to the features and their respective nodes that they define and what they are connected to. The neutral structure of the phenotype may be used to create a probable understanding of the pricing of the phenotype within context, as well as the possible deviations based at least in part on the probability. This information may be overlaid or compared in real-time with local codes and location-based pricing adjustments. For example, wood may be very expensive in one location and cheaper in another. The strength of this phenotype data structure or database design is that the real-estate system can attach multiple synapses to every node in order to provide different values in different locations.

TABLE 2

| | | | | | Total |
|---|---|---|---|---|---|
| Element | | | | | Estimated |
| Identifier | Element | Feature Description | Quantity | Price ($) | Cost ($) |
| CAB1 | Cabinet | Base Cabinets: Modular- | 25 | 5.00 | 125.00 |
| | | Standard (Quantity in | | | |
| | | Linear Feet) | | | |
| CAB2 | Cabinet | Upper Cabinets: Modular- | 25 | 3.50 | 88.00 |
| | | Standard (Quantity in | | | |
| | | Linear Feet) | | | |
| CL1 | Cleaning | Dishwasher: Standard | 1 | 250.00 | 250.00 |
| | Appliances | | | | |
| CL2 | Cleaning | Disposal: Standard | 1 | 175.00 | 175.00 |
| | Appliances | | | | |
| CL3 | Cooking | Range: Slide-In Standard | 1 | 375.00 | 375.00 |
| | Appliances | | | | |
| CL4 | Cooking | Microwave: Standard | 1 | 300.00 | 300.00 |
| | Appliances | | | | |
| CTI | Counters | Solid Surface (Quantity in | 23 | 10.00 | 230.00 |
| | | Linear Feet) | | | |
| D1 | Doors | Interior: Verneered | 1 | 65.00 | 65.00 |
| | | Solidcore | | | |
| E1 | Extras | Extra: Instant Hot Water | 1 | 120.00 | 120.00 |
| | | Standard | | | |
| E2 | Extras | Extra: Soap Dispenser | 1 | 40.00 | 40.00 |
| F1 | Faucet | Faucet: Lever, Standard | 1 | 130.00 | 130.00 |
| FL2 | Flooring | Laminate (Quantity in | 165 | 3.50 | 578.00 |
| | | Square Feet) | | | |
| L1 | Laundry | Washer: Standard | 1 | 500.00 | 500.00 |
| | Appliances | | | | |
| L2 | Laundry | Dryer: Standard | 1 | 375.00 | 375.00 |
| | Appliances | | | | |
| LT1 | Lighting | Lighting: Recessed Can | 4 | 35.00 | 140.00 |
| R1 | Refrigerators | Refrigerator: Free-Standing, | 1 | 1,200.00 | 1,200.00 |
| | | Luxury | | | |
| S1 | Sinks | Double-Bowl Stainless | 1 | 125.00 | 125.00 |
| | | Steel Luxury | | | |
| V1 | Ventilation | Hood-Unit: Ducted | 1 | 180.00 | 180.00 |
| | | Standard | | | |
| W1 | Walls | Wallboard (Quantity in | 70 | 2.00 | 140.00 |
| | | Square Feet) | | | |
| WND1 | Windows | Sliding | 2 | 120.00 | 240.00 |
| O1 | Other | | | | 0.00 |
| | Total | | | 4,014.00 | 5,375.00 |

In order to tie these capabilities together, the real-estate system may use ML that provide pricing for every phenotype. The reason for this is that, with the phenotype, the real-estate system can perform a basic calculation of the pricing (adding the features and multiplying weight percentages). In some embodiments, however, this naive way of determining valuation may not be sufficient. Instead, the real-estate system may need to understand a phenotype in context, because the pricing can change relative to the context independent of the phenotype (e.g., connecting wood to wood versus wood to concrete can affect the labor price). Therefore, the real-estate system may need to understand how the phenotype is related to the entire architectural design. While this is typically done manually by experts there is a high level of inaccuracy because of the complexity and the existing approach cannot be readily scaled. Furthermore, usually different experts report or provide different results. By using the ML, the real-estate system may be able to correct these inaccuracies through training, and the real-estate system may be able to deliver a real-estate system that is consistent, fast, scalable and/or accurate.

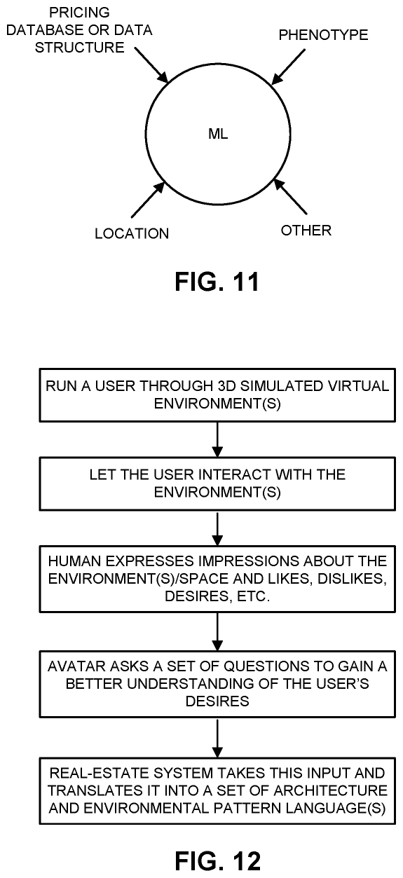

As shown in FIG. 11, which presents a drawing illustrating an example of ML inputs, the inputs for the ML may include the phenotype, surrounding linked phenotype(s), the pricing data structure or database, the location, and/or a price ratio for this location. These inputs may be sufficient to create a basic priced phenotype, as well as to price the phenotype in context, such as the location and relationship to the surrounding phenotypes that it is part of.

### Training the AI/ML Avatar

In some embodiments, correlating or associating the human language patterns, world data structure or database pattern language and the avatar may involve training the avatar AI using ML. Notably, by providing multiple 3D environments (or other vectorized inputs) that represent a specific pattern, the real-estate system can train the real-estate system to: take a given environment and ask the real-estate system to list the associated language; and/or provide the real-estate system with language and ask the real-estate system to respond back with the associated environment.

A similar process may be used to understand the human experience. For example, the real-estate system can be trained to: take a user's experience and translate it into the relationship between their emotional content and the 3D environment; train the avatar to understand, articulate, and/or identify what the user is looking for; and/or once trained, the avatar may provide the user with desires and potential real-estate properties for purchase based at least in part on this training/learning experience.

### Avatar Architecture

The core avatar may be composed of or based at least in part on at least multiple basic elements: 3D+toAPL, APLto3D+, NLP3D+toAPL, APLto3D+NLP, APLtoFin, and/or an APL based-search engine. Moreover, the avatar makeup may include understanding the user/buyer's preferences in order to find what the buyers want. Note that a user may include: a real-estate professional (such as a realtor, a contractor, a landscaper, an architect, an interior designer, an investor, etc.), a prospective buyer, or an interested party (such as an individual that buys land, who develops or builds properties, the general public, urban planners, etc.).

In order to do so, the avatar may take or receive inputs from the user to create a pattern language. As shown in FIG. 12, which presents a drawing illustrating an example of an avatar makeup, the user may interact with or be put through 3D simulated environments where they can interact with the environment/space (in a virtual or a physical environment). As the user goes through this space, they may express their impressions, such as likes, dislikes, desires, etc. Moreover, in order to gain a better understanding, the avatar implemented by the real-estate system may ask an additional set of questions, such as the number of bedrooms and bathrooms, lighting preferences, home-style (bungalow, cottage, Victorian, etc.), farmhouse kitchen, etc. Then, the avatar may take this information and translate it into an architectural and environmental pattern language.

### Real World Architecture to APL Data Structure or Database

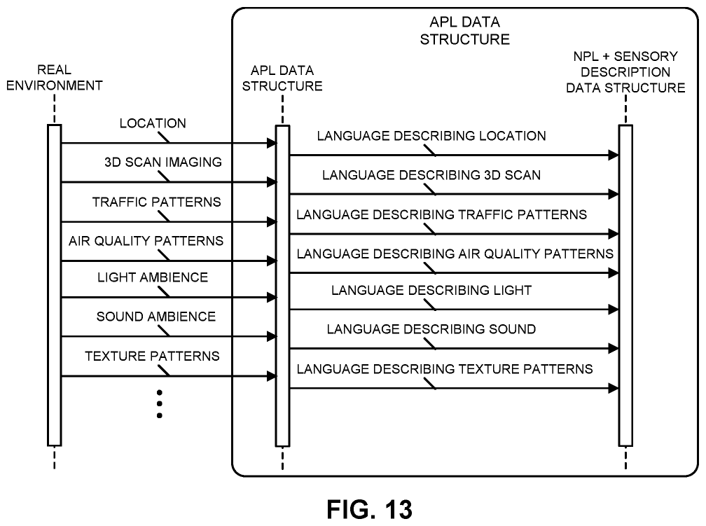

A variety of inputs may be stored in a predefined data structure, database or APL folder that may be used to translate the real environment to APL and optionally NLP and sensory descriptions. This is shown in FIG. 13, which presents a drawing illustrating an example of mapping 3D to APL and NLP. The initial part of this process may involve sending real-environment information (such as location, 3D scan imaging, traffic/air quality patterns, light/sound ambience patterns over time of day, changes to these inputs over time and dependent information like weather patterns and their impacts, etc.) to the real-environment APL data structure or database. The basic 3D environment may be translated into APL and NLP language sets that depict the APL descriptions in language that is: associated with the location, 3D scan imaging, light ambience and/or other characteristic(s) that are captured.

The information may be stored using a location code, such as an IPv6 address base translation of the real-world coordinates. This type of implementation may be used in order to ease the use in a virtual 3D environment and allow easy creation of AR systems. Note that real-world location coordinates may be translated into, e.g., an IPv6 address and, thus, may be consistent with both AR, VR and real-world coordinates.

Given a location address, the real-estate system can create a simulated virtual environment. In order to create a simulated virtual environment, the real-estate system may need to get the inputs that are patterns (traffic, sound, light, etc.).

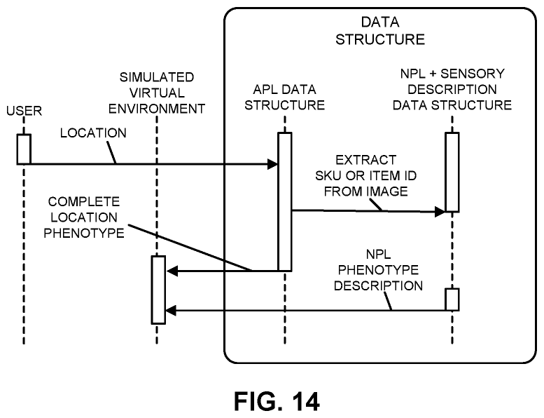

FIG. 14 presents a drawing illustrating an example of creating a simulated environment. A user may send the location to the APL data structure or database, which is also shared with the NLP and sensory description data structure or database. The APL data structure or database may take this location information and may send the simulated environment the location phenotype. Additionally, the NLP and sensory description data structure or database may send the NLP phenotype description. The combination of these phenotypes may allow the real-estate system to provide the simulated virtual environment that includes and renders real-estate property desired and captured by the user. Note that this may include, but is not limited to: location, traffic patterns, building layout, etc.

### Capturing Persona in APL

The APL was created by humans over an extended time interval (such as decades) and there may be repetitions within this architecture. Architectures and patterns may be created using rigid concepts that humans continue to come back to. However, the basics of language and grammar have not changed much over the years, and will likely stay the same or expand in the coming years. Therefore, as an individual moves through a real or a virtual environment, the real-estate system can translate this environment to APL (e.g., using a pretrained machine-learning model). Alternatively, the real-estate system can create the virtual environment from APL using mathematics or calculations.

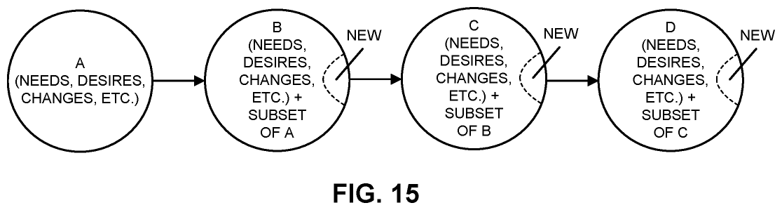

In order to build an avatar that represents a person or that can capture a person or an individual, the real-estate system may need to learn not only their likes and dislikes in a real or a virtual environment (with one or more initial real-estate properties), but also their desired changes in that real or virtual environment. Moreover, in order to identify and learn these desired changes, the AI/ML may offer different options to change a virtual environment using APL. Because APL is a natural language, rooted in a NLP dictionary, and is well and easily understood by humans, the real-estate system may use this language to obtain concrete outcomes from APL. FIG. 15 presents a drawing illustrating an example of building an avatar.

As a person expresses their feelings about a real or a virtual environment, it can be translated into an avatar that represents them in that specific virtual environment. In order to get a comprehensive and true representation of a persona of a user, multiple real or virtual environments may need to be translated (e.g., 3-10 real or virtual environments). In a given real or virtual environment, several attributes can be captured, such as: the architecture of the real or virtual environment, users' likes and dislikes, desires and desired changes, voice and movement analysis, emotional content, etc.

Within the given real or virtual environment, the real-estate system may ask the user a set of questions and/or direct actions to get information from the user about the real or virtual environment (e.g., what do you like vs dislike). Capturing this type of information may be used to create weights to establish how well a real or virtual environment fits the persona's needs (such as likes/dislikes, emotions, etc.). This same process may occur for each real or virtual environment the user is put into. Within these real or virtual environments, there will be commonalities.

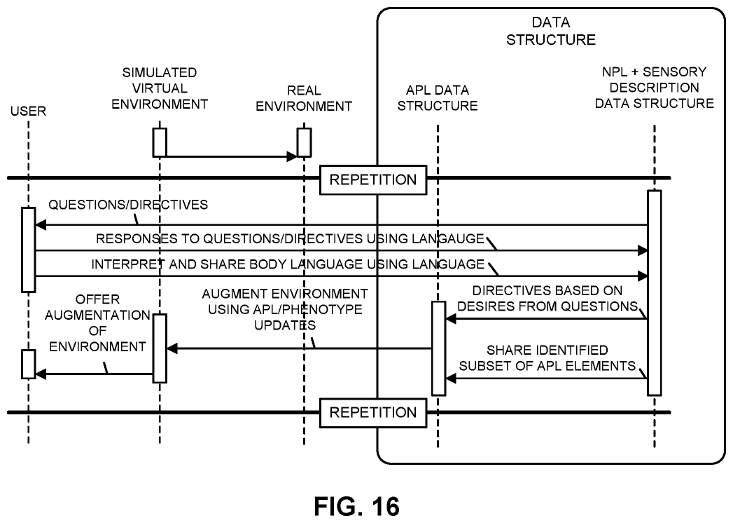

As shown in FIG. 16, which presents a drawing illustrating an example of building a phenotype based at least in part on human interaction and experience, as the user is placed into new virtual environments, the real-estate system may keep the pleasant aspects of past virtual environments with a small fraction of the virtual environment portraying new things. Moreover, the real-estate system may continue adding new aspects of the virtual environment to narrow down the user's persona/likes/dislikes. Naturally, over time, the real-estate system will get to a place that the represented virtual environment suits the needs of the user very well and there is little to be changed, if at all. For example, the accuracy of the representation may be better than 85, 90, 95 or 98%. This process gives a representation, in APL, of an architecture that is extremely satisfying to the user and a good representation of their persona (including but not limited to color, light, sound, layout, building style, etc.).

FIG. 16 above depicts the process of building a phenotype based at least in part on human interactions and experiences within a given virtual environment. In order to build a user/avatar phenotype, the NLP data structure or database may be used to provide the user/human a set of questions/directives in order to understand what they like/dislike about a given environment. The human responds to these questions/directives and the response plus their unique body language may be stored in the NLP data structure or database. Moreover, the NLP data structure or database may share the directive responses with the APL data structure or database in order to create a simulated virtual environment from a pattern language. The APL data structure or database may share the phenotype updates and augmentations that are generated based at least in part on the responses to the simulated virtual environment. Furthermore, the simulated virtual environment may render or provide this virtual environment to the human and may offer further augmentation in order to better understand their desired virtual environment. This process may continue until the user/human is satisfied with the virtual environment (including one or more particular real-estate properties) and that their desires have been met.

### Avatar Behavioral Hysteresis

When we move between virtual environments (with, e.g., different real-estate properties), the real-estate system may attempt to ensure consistent behavior between the virtual environments. More specifically, the real-estate system may ensure that the human representation is consistent. This process may rely in part on human emotional qualifiers, decisiveness, state of mind, etc. There are some techniques in psychology that help create a consistent state of mind. However, the real-estate system may not require or expect this to be done by everyone. Therefore, the real-estate system may use technology to compensate for this deficiency.

In order to address potential consistency issues, in the virtual environments provided to a particular user the real-estate system may repeat both satisfactory and unsatisfactory elements to ensure and measure the outcomes. We expect the same outcomes in each of these virtual environments. For example, the real-estate system may take likes and a few dislikes from virtual environment A and translate this into virtual environment B. In principle, the real-estate system should get the same outputs for repeated likes and dislikes, plus outputs from the newly introduced elements in virtual environment B.

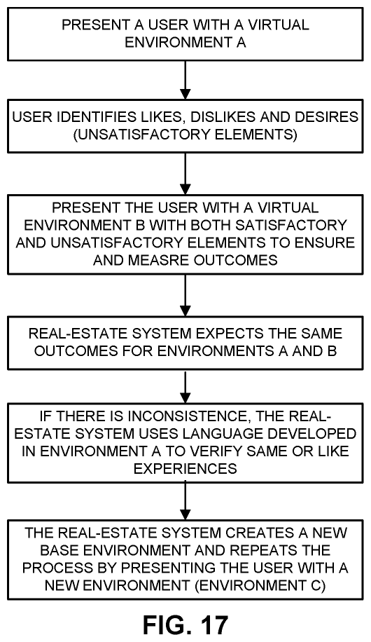

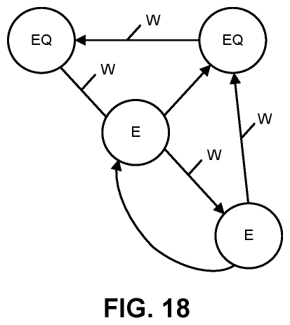

When this consistency does not occur, the real-estate system may use the language developed/captured in virtual environment A to verify same or like experiences. If the inconsistency level is above some delta or threshold set in the real-estate system (such as 5, 10 or 15%), the real-estate system may need to forgo virtual environment A and use virtual environment B as the base virtual environment and repeat with a new virtual environment C hoping to get better results. This process is shown in FIG. 17, which presents a drawing illustrating an example of avatar behavioral hysteresis.

### Merging Personas and Avatar Capabilities and Tendencies

Merging personas can be achieved using emotional weights. For example, two avatar APLs can be compared to identify how each element of an APL weighs with emotional qualifiers. A scale can be used to represent the level of agreement of emotional qualifiers between the APLs and an element can be chosen based at least in part on this value. When there are common elements between different personas, the emotional weights of the elements may be combined (e.g., using the average or a weighted average) and the commonalities are merged. Alternatively, different elements may be added with their own scale and a mixed persona may be created. This process is shown in FIG. 18, which presents a drawing illustrating an example of merging persona weights.

Note that weights are associated with how important different elements are to a specific persona. This is how the real-estate system may build the persona into an avatar, or how the real-estate system may represent what a user really desires in their home. The use of weights and merging of personas can be achieved using a neural network (NN) or a neural network technique. However, more generally, a machine-learning technique may be used.

The following is a description of an example of a neural network or a directed graph used to articulate a phenotype designed by a user or modified by a user. There are several parts to this phenotype.

In the present discussion, note that a genotype is a detailed phenotype structure or the makings of a phenotype. In general, the real-estate system may break a phenotype into nodes (or genes) and connectors/links that are the synapse. There may be more information inside the synapse than just the weights. A genome or genotype may represent all of the data which encapsulated (or is captured) inside the phenotype structure. Note that the genotype may need a list of node genes (which are the neurons and, in our case, the APLE(s) and a detailed description of the connections genes that are the synapse connecting neurons or the features), directions and connected neurons as described by the synapse structures.

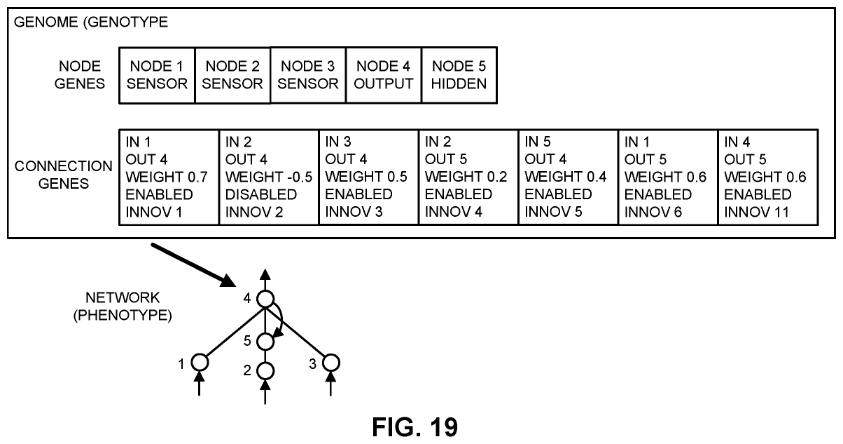

In FIG. 19, which presents a drawing illustrating an example of producing phenotypes using genotypes, we depict a genotype that produces the illustrated phenotype. There are three input nodes, one hidden node, one output node, and seven connection definitions (one of which is recurrent). The second gene is disabled, so the connection that it specifies (between nodes 2 and 4) is not expressed in the phenotype. Note that disabled nodes belong to genes that are not expressed but are a potential in this architecture. For example, an architectural design that includes architecture elements that a user does not like or desires to omit.

The Innov (which is sometimes referred to as an innovation number) refers to emotional content attached to specific features. The real-estate system may use it to maintain history of changes, e.g., the evolution of this phenotype, which plays a major role in combining two phenotypes into a new one that includes features and elements from both.

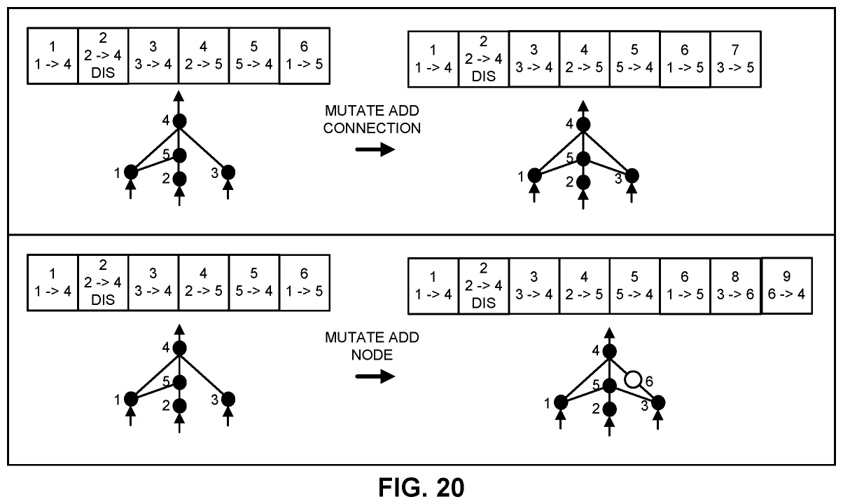

FIG. 20 presents a drawing illustrating an example of adding nodes and connections. There are two types of structural mutation in an APL phenotype. Both types (adding a connection and adding a node) are illustrated with the connection genes of a network shown above their phenotypes. The top number in each genome is the innovation number of that gene. The innovation numbers are historical markers that identify the original historical ancestor of each gene. New genes are assigned new, increasingly larger, numbers. When adding a connection, a single new connection gene may be added to the end of the genome and given the next available innovation number. Moreover, when adding a new node, the connection gene being split may be disabled, and two new connection genes may be added to the end of the genome. The new node is between the two new connections. A new node gene (not depicted) representing this new node may also be added to the genome.

This genetic encoding technique is designed to allow corresponding genes to be easily lined up when two genomes cross over during mating. As shown in FIG. 19, genomes are linear representations of network connectivity. Each genome may include a list of connection genes, each of which refers to at least two node genes being connected. Node genes may provide a list of inputs, hidden nodes, and outputs that can be connected. Each connection gene may specify the in-node, the out-node, the weight of the connection (whether or not the connection gene is expressed via an enable bit), and/or an innovation number, which, as described further below, allows corresponding genes to be found.

Mutation can change both connection weights and network structures. Connection weights mutate as in an arbitrary neural evolution neural network system (NE system), e.g., evolving an initial neural network using an evolutionary technique to grow or modify the neural network based at least in part on feedback associated with an output of the neural network, with each connection either perturbed or not in each generation. As shown in FIG. 20, structural mutations may occur in two ways. Notably, each mutation may expand the size of the genome by adding gene(s). In an add connection mutation, a single new connection gene with a random weight may be added connecting two previously unconnected nodes. In an add node mutation, an existing connection may be split and the new node may be placed where the old connection used to be. The old connection may be disabled and two new connections may be added to the genome. The new connection leading into the new node may receive a weight of, e.g., ‘1’, and the new connection leading out may receive the same weight as the old connection. This approach for adding nodes was chosen in order to minimize the initial effect of the mutation. The new nonlinearity in the connection may change the function slightly, but new nodes can be immediately integrated into the network, as opposed to adding extraneous structure that would have to be evolved into the network later. In this way, because of specification, the network may have time to optimize and make use of its new structure. In some embodiments, the use of mutation may be used when real-estate property is passed from a parent to a child. For example, a child may want to keep some of their parent's touches, but may also want to make some renovations to a real-estate property of their own. Using the real-estate system, a child can ‘inherit’ their parent's avatar and can integrate their genetic makeup with it to create their own avatar.

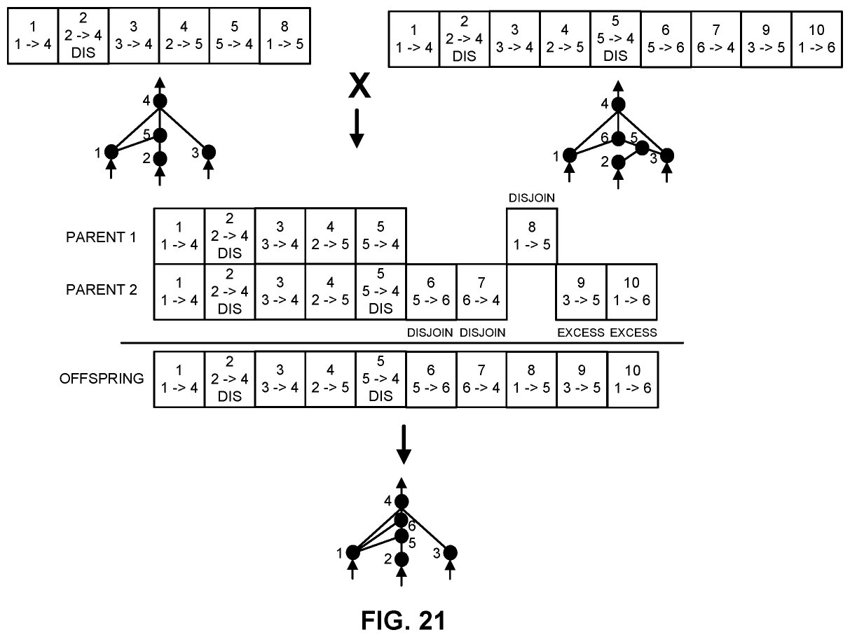

FIG. 21 presents a drawing illustrating an example of matching genomes for different network topologies using innovation numbers. Although parent 1 and parent 2 look different, their innovation numbers (shown at the top of each gene) tell us which genes match up. Even without any topological analysis, a new structure that combines the overlapping parts of the two parents as well as their different parts can be created. Matching genes may be inherited randomly, while disjoint genes (e.g., those that do not match in the middle) and excess genes (e.g., those that do not match in the end) may be inherited from the more-fit parent. In this example, equal fitness may be assumed, so the disjoint and excess genes may also be inherited randomly. Note that the disabled genes may become enabled again in future generations. Thus, there is a preset chance or probability that an inherited gene may be disabled if it is disabled in either parent.

### Privacy Protection of Avatars

The privacy of an avatar/persona/APL may be maintained by the real-estate system. A user's APL may be unique to them and can reveal many things about the user, such as their likes and dislikes, desires, potential location or desired location, etc. In order to protect a persona, a user's avatar may be protected using an electronic wallet and may be placed onto a blockchain. Changes to the avatar may be made using blockchain transactions and may only be accessible by the wallet owner.

In order to protect the entire real-estate system, changes may not be stored in the real-estate system. Instead, the changes may only be stored on the blockchain associated with that specific wallet. This leaves the real-estate system knowing nothing about the person or user. Once again, instead all changes and transactions may be stored on the blockchain.

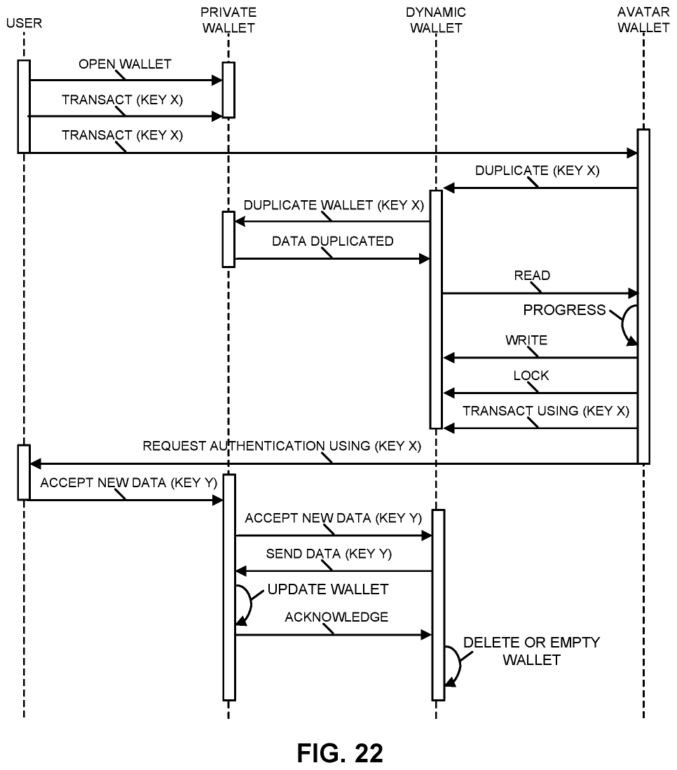

As shown in FIG. 22, which presents a drawing illustrating an example of privacy protection of avatars, the user may have several wallets, such as a private, dynamic and avatar wallet. When the user makes changes to their avatar, the user may request to transact with their avatar wallet in order to get stored data from their private wallet. This data may be read, processed, and transactions may be recorded on the blockchain. Moreover, the avatar wallet may request authentication prior to accepting new data on the private wallet. Once the private wallet is updated and the dynamic wallet has acknowledged this, the dynamic wallet may be emptied or deleted.

While blockchain is used as an illustration in the preceding discussion, more generally an avatar may be uniquely tied to a user. Thus, in some embodiments, one or more other security (such as encryption) and/or authentication techniques may be used.

### Trading Avatars

Avatars can be sold or traded between users. Avatar trading may be based at least in part on the same blockchain concept used for avatar privacy. In general, a user can trade/sell/buy some or all of a persona, APL, or avatar. For example, a user may only want one aspect of the persona, such as the persona for a New York, contemporary penthouse. Alternatively, the user may want the persona for an industrial farmhouse style home with three bedrooms and two baths.

The buying, selling and trading of avatars may be performed through a blockchain-based technology and wallet system. Thus, wallets may not only include the user's personally developed persona/avatar/APL, but also any other personas/avatars/APLs that they have bought or traded. While each persona/avatar is unique, they can be updated over time without limitation. These updates can be provided to users that have purchased the persona/avatar as an ‘update’ and will result in a new version of the avatar in their wallet.

### Using Gameplay to Understand Persona APL

A user may use some or all of the aforementioned architectural elements to build or identify a house or residence and, more generally, a real-estate property, which may be a portion or all of a building. (Thus, in the present discussion, a residence may include: an apartment, a condominium, a townhome, a duplex, a house, a building, etc.) As the user builds this residence or creates their environment (albeit virtually), the user dynamically generates the synapses and dependencies (as described previously in the description of the neural network). While the gameplay pricing may not be directly associated with the additions the user is making while building the residence, the user can request that the residence created be priced out based at least in part on the included elements and features. Because the real-estate system is using a game-play environment that reflects the real world, the real-estate system may map the coordinates to the real world and may feed the ML shown in FIG. 16 with the data to price this model (phenotype). Thus, in some embodiments, the real-estate system may compute what would it cost to develop this house, condominium, etc. in real life.

### Financial Planning

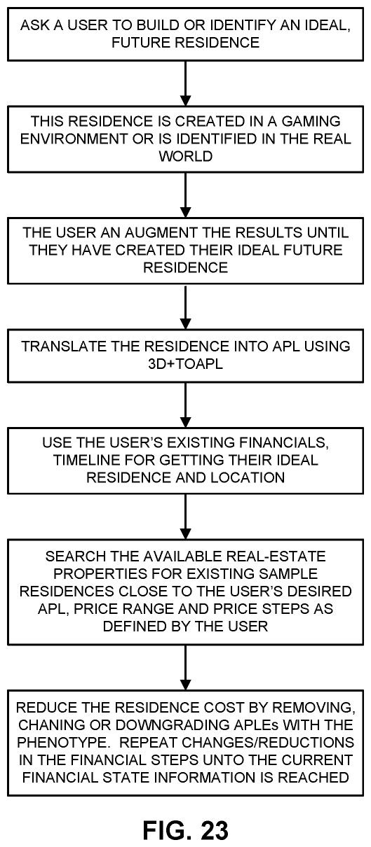

For financial planning, the real-estate system may provide one or more tool(s), including that the real-estate system may ask the user to build or identify their ideal, future home. This residence may be created in the game environment or may be identified in the real world for this user. Moreover, via the real-estate system, the user may augment the results until they identify an ideal future residence. Furthermore, the real-estate system may translate the residence into APL (using 3D+toAPL). Additionally, the real-estate system may use the user's existing financials and/or their financial history, and how fast he/she would like to get to their ideal APL home and location. Note that the real-estate system may search the available database or data structure for existing example residences close to or that are similar to the ideal APL and within the price range and price steps defined by the user (or a financial professional, such as a mortgage broker). In another aspect of the planning, the real-estate system may reduce the home cost by removing APLE or change/downgrade some of the APLEs within the phenotype to reduce pricing. The real-estate system may repeat these reductions in the desired financial operations until it reaches the current financial state information. FIG. 23 presents a drawing illustrating an example of a financial planning call flow.

The real-estate system as a financial planning vehicle can assess personal microeconomic standing and potential in a resilient financial forecast to achieve real-estate and lifestyle goals through real-estate acquisition and leasing opportunities. Users can utilize the real-estate system to engineer and reverse engineer their financial future. Moreover, by identifying an ideal residence of today or an ideal living scenario and linking to a user's current financial data, the real-estate system can create a flexible real-estate investment plan that will guide a user through their stages of life to their ultimate lifestyle (or real estate) goal.

Imagine being a college student interested in buying a home and getting started in real estate investing, or have a family and looking to move from a balcony baby condominium to owning a house with a yard. The real-estate system can be used to tour a variety of properties and to identify elements of those properties that are desired. For example, the knowledge about a user's desires and/or needs can be used to identify potential real-estate properties. Then, the user can virtually and interactively tour these real-estate properties using the real-estate system. Moreover, the identified real-estate properties may be filtered based at least in part on the aforementioned financial analysis and constraints.

Thus, a user can design their own ‘dream home,’ aided by the architectural AI to craft an idea of where the user may want to live in their 30s, 40s, 50s, 60s and beyond or to find a property where aging-in-place is ideally possible. Consequently, users can link finances so the real-estate system can find properties that are financially accessible at the user's current stage of life.

As a user's financial situation evolves, the real-estate system can recommend to sell a currently owned property, because it has found a property it believes the user will like next, and it can ‘see’ the user is ready to make that step up from their starter home to the next level. Thus, the real-estate system may help the user financially plan throughout their life via a 3D virtual environment corresponding to the user's avatar(s).

On a more granular level, by accessing information specifying a user's ongoing financial history, the real-estate system can monitor a user's spending habits and revenue (and, more generally, financial activity and transactions) to make dynamic recommendations in real-time that keep the user on track to make that next move in line with personal timelines and goals. Consequently, while a user may be able to take a vacation, it may mean that the user is going to have to wait another year to buy that next house. If the prices in the market keep going up, the user may get priced out, and their next house may be more prosaic than luxurious.

For users who want to own multiple investment properties, the real-estate system can identify good long-term and short-term rental properties from residential single-family houses to multifamily buildings or commercial real estate, guiding users as they build a real-estate portfolio. In the process, the real-estate system may keep the users ‘eyes on the prize,’ guiding them to their future as it evolves based at least in part on their current choices.

In effect, the real-estate system may allow users to visualize their future and to see where they are going. Table 3 provides an example of financial modeling.

TABLE 3

| Feature | Value |
|---|---|
| User | John Smith |
| Bank Balance | $1,000,000 |
| Income (Monthly) | $15,000 |
| Stock Investments | $500,000 |
| Crypto-Current Investments | $200,000 |
| Real-Estate Investments | $8,000,000 |
| Other Investments | $0.00 |
| Credit Score | 780 |
| Fixed Expenses (Monthly) | $9,000.00 |
| Variable Expenses (Monthly) | $7,000.00 |
| Goal 1 Probability | 100% (Buy Now) |
| Goal 2 Probability | 68% (Wait Approximately 2 Years) |
| Goal 3 Probability | 25% (Wait Approximately 5 Years) |
| Goal 4 Probability | 2% (Wait Approximately 15 Years) |

Because the avatars in the real-estate system are linked to blockchain, and are securely tied to the users, they can access the user's financial information, giving them an understanding of their finances that would rival that of an accountant or a financial professional. Via their avatar, the real-estate system can advise the user in real-time about spending decisions, evaluate investment plans, track productivity, and identify new more beneficial behavioral patterns that are actionable to the user in a deeply personal way.

While other financial services that allow users to link in their financial data or history are available, the avatars in the real-estate system work in the best interest of the user. This means that, if a user wants to live a simple life, and work in the gig economy while maintaining low overhead so they can spend most of their time camping, the avatar can help them focus on habits that allow them to do that without making recommendations for a lifestyle that they do not want. Alternatively, if a user, starting with nothing, wants to become a real-estate investor and buy multiple residential or commercial properties, the avatar can guide them to actionable behavioral patterns that will help them succeed.

This highly malleable form of financial planning can work for a wide range of individuals with distinct aspirations and goals. Moreover, using this approach, a user may change their goals at any time and the real-estate system can adapt to their new needs/desires.

While the preceding embodiments illustrate communication between components and/or electronic devices using unidirectional or bidirectional communication with lines having single arrows or double arrows, in general the communication in a given operation in the preceding embodiments may involve unidirectional or bidirectional communication.

Moreover, while the preceding embodiments were illustrated with particular components, inputs and outputs, in other embodiments there may be: fewer or additional inputs, outputs or components; two or more components may be combined; a component may be moved; and/or an input, an output or a component may be changed.

We now describe embodiments of an electronic device, which may perform at least some of the operations in the search techniques. FIG. 24 presents a block diagram illustrating an example of an electronic device 2400 in accordance with some embodiments, such as one of electronic devices 110, one of access points 114, base station 116, one of computers 120, etc. This electronic device includes processing subsystem 2410, memory subsystem 2412, and networking subsystem 2414. Processing subsystem 2410 includes one or more devices configured to perform computational operations. For example, processing subsystem 2410 can include one or more microprocessors, ASICs, microcontrollers, programmable-logic devices, one or more graphics process units (GPUs) and/or one or more digital signal processors (DSPs).

Memory subsystem 2412 includes one or more devices for storing data and/or instructions for processing subsystem 2410 and networking subsystem 2414. For example, memory subsystem 2412 can include dynamic random access memory (DRAM), static random access memory (SRAM), and/or other types of memory. In some embodiments, instructions for processing subsystem 2410 in memory subsystem 2412 include: one or more program modules or sets of instructions (such as program instructions 2422 or operating system 2424), which may be executed by processing subsystem 2410. Note that the one or more computer programs may constitute a computer-program mechanism. Moreover, instructions in the various modules in memory subsystem 2412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 2410.

In addition, memory subsystem 2412 can include mechanisms for controlling access to the memory. In some embodiments, memory subsystem 2412 includes a memory hierarchy that comprises one or more caches coupled to a memory in electronic device 2400. In some of these embodiments, one or more of the caches is located in processing subsystem 2410.

In some embodiments, memory subsystem 2412 is coupled to one or more high-capacity mass-storage devices (not shown). For example, memory subsystem 2412 can be coupled to a magnetic or optical drive, a solid-state drive, or another type of mass-storage device. In these embodiments, memory subsystem 2412 can be used by electronic device 2400 as fast-access storage for often-used data, while the mass-storage device is used to store less frequently used data.

Networking subsystem 2414 includes one or more devices configured to couple to and communicate on a wired and/or wireless network (i.e., to perform network operations), including: control logic 2416, an interface circuit 2418 and one or more antennas 2420 (or antenna elements) and/or input/output (I/O) port 2430. (While FIG. 24 includes one or more antennas 2420, in some embodiments electronic device 2400 includes one or more nodes, such as nodes 2408, e.g., a network node that can be coupled or connected to a network or link, or an antenna node or a pad that can be coupled to the one or more antennas 2420. Thus, electronic device 2400 may or may not include the one or more antennas 2420.) For example, networking subsystem 2414 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 2414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 2400 may use the mechanisms in networking subsystem 2414 for performing simple wireless communication between the electronic devices, e.g., transmitting advertising or beacon frames and/or scanning for advertising frames transmitted by other electronic devices as described previously.

Within electronic device 2400, processing subsystem 2410, memory subsystem 2412, and networking subsystem 2414 are coupled together using bus 2428. Bus 2428 may include an electrical, optical, and/or electro-optical connection that the subsystems can use to communicate commands and data among one another. Although only one bus 2428 is shown for clarity, different embodiments can include a different number or configuration of electrical, optical, and/or electro-optical connections among the subsystems.

In some embodiments, electronic device 2400 includes a display subsystem 2426 for displaying information on a display, which may include a display driver and the display, such as a liquid-crystal display, a multi-touch touchscreen, etc.

Electronic device 2400 can be (or can be included in) any electronic device with at least one network interface. For example, electronic device 2400 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, an augmented-reality device, a virtual-reality device, a headset, a portable computing device, an access point, a transceiver, a router, a switch, communication equipment, a computer network device, a stack of computer network devices, a controller, test equipment, a printer, and/or another electronic device.

Although specific components are used to describe electronic device 2400, in alternative embodiments, different components and/or subsystems may be present in electronic device 2400. For example, electronic device 2400 may include one or more additional processing subsystems, memory subsystems, networking subsystems, and/or display subsystems. Additionally, one or more of the subsystems may not be present in electronic device 2400. Moreover, in some embodiments, electronic device 2400 may include one or more additional subsystems that are not shown in FIG. 24, such as a user-interface subsystem 2432. Also, although separate subsystems are shown in FIG. 24, in some embodiments some or all of a given subsystem or component can be integrated into one or more of the other subsystems or component(s) in electronic device 2400. For example, in some embodiments program instructions 2422 are included in operating system 2424 and/or control logic 2416 is included in interface circuit 2418.

Moreover, the circuits and components in electronic device 2400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 2414 (or, more generally, of electronic device 2400). The integrated circuit may include hardware and/or software mechanisms that are used for transmitting wireless signals from electronic device 2400 and receiving signals at electronic device 2400 from other electronic devices. Aside from the mechanisms herein described, radios are generally known in the art and hence are not described in detail. In general, networking subsystem 2414 and/or the integrated circuit can include any number of radios. Note that the radios in multiple-radio embodiments function in a similar way to the described single-radio embodiments.

In some embodiments, networking subsystem 2414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the search technique may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the search technique may be implemented using program instructions 2422, operating system 2424 (such as a driver for interface circuit 2418) or in firmware in interface circuit 2418. Alternatively or additionally, at least some of the operations in the search technique may be implemented in a physical layer, such as hardware in interface circuit 2418.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the search technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a computation circuit, coupled to the interface circuit, configured to execute program instructions; and
memory, coupled to the computation circuit, configured to store a user profile associated with a first individual and the program instructions, wherein, when executed by the computation circuit, the program instructions cause the computer system to perform operations comprising:
receiving a search query associated with a second individual;
accessing the user profile, wherein the user profile comprises information specifying real-estate interests of the first individual;
performing a search of available real-estate properties based at least in part on the search query and the user profile; and
presenting search results in a virtual environment, wherein the virtual environment comprises an avatar corresponding to the first individual and a three-dimensional (3D) representation of a real-estate property, and
wherein the virtual environment is configured to allow the avatar to dynamically explore and view the real-estate property.

2. The computer system of claim 1, wherein the first individual is different from the second individual.

3. The computer system of claim 1, wherein the first individual and the second individual are related.

4. The computer system of claim 1, wherein the user profile comprises real-estate elements that the first individual likes or dislikes, and the information is expressed in an architectural language.

5. The computer system of claim 1, wherein the operations comprise:
receiving feedback about the real-estate property; and
dynamically modifying the user profile based at least in part on the feedback.

6. The computer system of claim 5, wherein the dynamic modification comprises translating the feedback into an architectural language used to express the information.

7. The computer system of claim 5, wherein the feedback comprises a tag assigned to a real-estate element in the real-estate property by the second individual.

8. The computer system of claim 5, wherein the feedback comprises second information specifying an emotional response of the second individual.

9. The computer system of claim 8, wherein the second information comprises one or more images of the second individual, and the one or more images comprise a gesture, a facial expression, body motion, or body language of the second individual.

10. The computer system of claim 5, wherein the feedback comprises natural language of the second individual.

11. The computer system of claim 5, wherein the dynamic modification is performed by a pretrained supervised-learning model.

12. The computer system of claim 11, wherein the operations comprise retraining the pretrained supervised-learning model based at least in part on the modified user profile.

13. The computer system of claim 1, wherein the virtual representation presents the real-estate property in a 3D context of a second environment that comprises the real-estate property.

14. The computer system of claim 13, wherein the context comprises: a building that comprises the real-estate property; or one or more buildings that are proximate to the real-estate property.

15. A non-transitory computer-readable storage medium for use in conjunction with a computer system, the computer-readable storage medium storing program instructions that, when executed by the computer system, causes the computer system to perform operations comprising:
receiving a search query associated with a second individual;
accessing a user profile, wherein the user profile comprises information specifying real-estate interests of a first individual;
performing a search of available real-estate properties based at least in part on the search query and the user profile; and
presenting search results in a virtual environment, wherein the virtual environment comprises an avatar corresponding to the first individual and a three-dimensional (3D) representation of a real-estate property, and
wherein the virtual environment is configured to allow the avatar to dynamically explore and view the real-estate property.

16. The non-transitory computer-readable storage medium of claim 15, wherein the first individual is different from the second individual.

17. The non-transitory computer-readable storage medium of claim 15, wherein the operations comprise:
receiving feedback about the real-estate property; and
dynamically modifying the user profile based at least in part on the feedback.

18. A method for performing a search, comprising:
by a computer system:
receiving a search query associated with a second individual;
accessing the user profile, wherein a user profile comprises information specifying real-estate interests of a first individual;
performing the search of available real-estate properties based at least in part on the search query and the user profile; and
presenting search results in a virtual environment, wherein the virtual environment comprises an avatar corresponding to the first individual and a three-dimensional (3D) representation of a real-estate property, and
wherein the virtual environment is configured to allow the avatar to dynamically explore and view the real-estate property.

19. The method of claim 18, wherein the first individual is different from the second individual.

20. The method of claim 18, wherein the method comprises:
receiving feedback about the real-estate property; and
dynamically modifying the user profile based at least in part on the feedback.
